(19) United States
(12) Patent Application Publication
(10) Pub. No.: US 2026/0288723 A1
(43) Pub. Date: Sep. 24, 2026

(54) SYSTEM

(71) Applicant: SoftBank Group Corp., Tokyo (JP)

(72) Inventor: Takahiro NAKAMICHI, Tokyo (JP)

(73) Assignee: SoftBank Group Corp., Tokyo (JP)

(21) Appl. No.: 19/567,011

(22) Filed: Mar. 14, 2026

(30) Foreign Application Priority Data
Mar. 19, 2025 (JP) 2025-045015

(51) Int. Cl. G06F 16/2453; G06F 16/242; G06F 16/2452

(52) U.S. Cl. CPC G06F 16/24542; G06F 16/242; G06F 16/24522

(57) ABSTRACT

A system includes a processor that is configured to input a prompt sentence into a generative AI model to generate a virtual person based on a user goal, analyze behavior of the generated virtual person, and present the analyzed behavior to the user.

### CROSS-REFERENCE TO RELATED APPLICATION

This application is based on and claims priority under 35 USC 119 from Japanese Patent Application No. 2025-045015 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional goal-support systems and coaching applications typically present static advice, generalized action lists, or simple reminders that are not sufficiently personalized to the user's specific goal, context, and behavioral tendencies. Such systems often fail to provide a vivid and actionable representation of how a successful version of the user would actually behave in daily life. As a result, the user has difficulty understanding concrete steps that lead from the current state to the desired state, and motivation and adherence over time tend to be low.

Furthermore, existing systems do not fully leverage generative AI models to simulate a coherent, goal-achieving virtual person whose behaviors can be dynamically analyzed and translated into tailored guidance. In particular, there is a lack of mechanisms that (i) automatically construct prompts to a generative AI model based on a user goal, (ii) analyze the resulting virtual person's behaviors, and (iii) present those behaviors in a way that effectively induces the user to adjust real-world actions. Accordingly, there is a need for a system that can generate a virtual person aligned with a user goal, simulate and analyze the behavior of that virtual person, and provide the user with concrete, selectable action options that guide the user's own behavior toward goal achievement.

### SUMMARY

To solve the above-described problems, the present invention provides a system comprising a processor, wherein the processor is configured to input a prompt sentence into a generative AI model to generate a virtual person based on a user goal, analyze behavior of the generated virtual person, and present the analyzed behavior to the user. By doing so, the system leverages the generative AI model to produce a virtual person that represents a future, goal-achieving self of the user, and extracts actionable behavioral patterns from the generated content.

In one aspect, the processor is configured to generate a prompt sentence that instructs the generative AI model to execute a behavior simulation in order to imitate specific actions toward achievement of the user goal. The processor can, for example, incorporate the user goal, time frame, and contextual constraints into the prompt sentence, and cause the generative AI model to output detailed daily or periodic behaviors of the virtual person. The processor then analyzes these simulated behaviors and identifies concrete actions that are relevant and feasible for the user.

In another aspect, the processor is configured to present the behavior of the virtual person to the user in a manner that guides behavior of a real self of the user with reference to the behavior of the virtual person, and to present options of actions based on a prompt sentence generated using the generative AI model. The processor can, for instance, transform the analyzed behaviors into a set of explicit recommendations or selectable action options, such as specific diet steps, exercise routines, or study tasks, and present them through a user interface. By repeatedly generating, analyzing, and presenting the virtual person's behavior and associated action options, the system enables the user to refer to the virtual behavior and progressively adjust the user's real-world behavior toward the desired goal.

The term “processor” refers to any hardware component or combination of hardware components, including but not limited to a CPU, GPU, ASIC, FPGA, microcontroller, or a distributed set of such components, that is capable of executing instructions to perform the functions described in the present specification and claims.

The term “generative AI model” refers to a machine learning model, such as a large language model, image generation model, or multimodal generative model, that is trained to generate new content or data samples in response to input data, including prompt sentences, and that is capable of producing representations of a virtual person and associated behaviors.

The term “prompt sentence” refers to any textual or structured input, including a single sentence, multiple sentences, or a formatted prompt, that is provided to a generative AI model to control or condition the content generated by the generative AI model, such as the generation of a virtual person or a behavior simulation.

The term “virtual person” refers to a fictitious or simulated character, including a representation of a future, goal-achieving version of a user, that is generated by a generative AI model based on a user goal and that exhibits behaviors, actions, or decision patterns in the generated content.

The term “user goal” refers to any target state, objective, or desired outcome specified by a user, including but not limited to health-related goals, learning goals, work-related goals, or lifestyle goals, which serves as a basis for generating a virtual person and simulating behaviors.

The term “behavior of the virtual person” refers to actions, activities, routines, decisions, or sequences of operations that the virtual person is described or inferred to perform, as generated or output by the generative AI model in response to a prompt sentence.

The term “behavior simulation” refers to a process in which the generative AI model generates or predicts a series of behaviors of a virtual person over time or under specified conditions, in order to imitate specific actions directed toward achievement of a user goal.

The term “analyze behavior” refers to extracting, classifying, evaluating, or otherwise processing the behaviors of the virtual person generated by the generative AI model to derive structured information, patterns, or actionable items suitable for presentation to the user.

The term “present the analyzed behavior to the user” refers to outputting information derived from the analysis of the virtual person's behavior, by means of a display, speaker, notification system, or other user interface, in a human-perceivable form such as text, graphics, audio, or a combination thereof.

The term “options of actions” refers to a set of one or more concrete, selectable actions or recommendations presented to the user, each action being derived from or based on the behavior of the virtual person or a prompt sentence generated using the generative AI model, and intended to guide the user's real-world behavior toward the user goal.

The term “real self of the user” refers to the actual, physical user in the real world, as distinguished from the virtual person generated by the generative AI model, whose real-world behaviors are intended to be guided or influenced by reference to the behavior of the virtual person.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

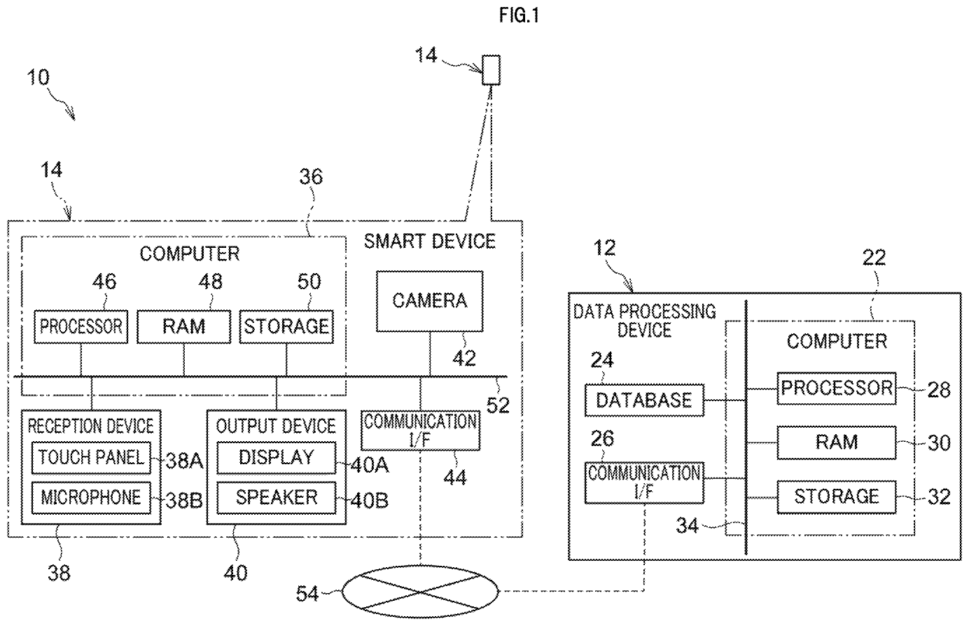

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

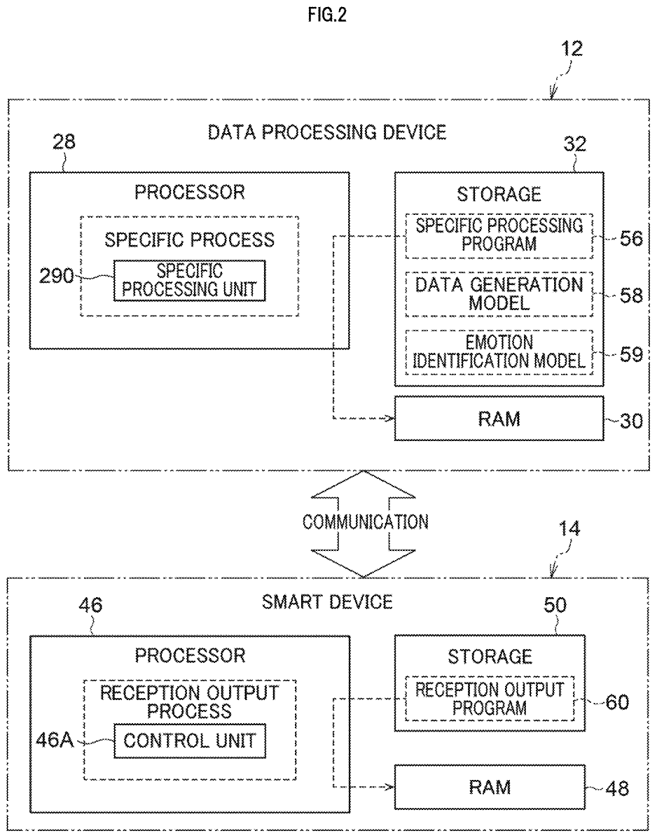

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### EXAMPLE 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional goal-support systems typically present static checklists or templates that are manually designed and only loosely tailored to a user's stated goal. Such systems generally rely on fixed rule sets or simple parameterized routines, and therefore cannot flexibly generate detailed, step-wise behavior plans adapted to diverse goal contents, time constraints, and user progress. As a result, even when generative artificial intelligence models are used in an ad hoc manner, they are usually invoked as standalone tools that return unstructured text, without a system-level mechanism to (i) systematically construct prompt sentences from user goals, (ii) parse the generated output into structured, machine-processable action plans, and (iii) iteratively refine those plans based on actual execution status.

From a computer-technology perspective, there is no integrated processing architecture that treats user goals, prompt sentences, model outputs, and user behavior logs as linked data objects managed by a processor to provide continuous, feedback-driven generation and updating of action plans. Existing architectures do not provide a processor-implemented pipeline that converts free-form goal text into a normalized internal representation, automatically generates a prompt sentence instructing a generative AI model to perform behavior simulation of a virtual person, transforms the resulting natural-language description into structured action-plan data with explicit temporal and categorical fields, and then algorithmically re-prompts the model in response to quantified achievement degrees. This lack of integration leads to several technical problems. First, the computing resources of the generative AI model are not efficiently used, because prompts are not systematically constrained to produce output in a structure that downstream components can reliably parse, leading to repeated, wasteful calls or manual post-processing. Second, the user terminal and the server are not coordinated in a way that allows the action plan to be represented internally as a structured data model (for example, elements with time, period, category, and description fields), limiting automatic scheduling, progress tracking, and dynamic UI rendering. Third, there is no standardized mechanism by which the processor can transform behavior-execution status information into update prompt sentences that direct the generative AI model to revise plans based on concrete performance metrics, resulting in a discontinuity between plan generation and plan adaptation.

Accordingly, there is a need for a computer-implemented system that improves the way in which processors interact with generative AI models by: (a) automatically generating task-constrained prompt sentences from user goals, (b) enforcing output formats that support deterministic parsing into structured action-plan information, and (c) performing feedback-driven, iterative updating of those plans using achievement degrees computed from behavior-execution status information. Such a system improves the functioning of the computer by enabling more efficient model invocation, reducing parsing errors, allowing the server to maintain an internal, structured representation of user-specific behavior plans, and enabling the user terminal to present dynamically updated task lists and schedules based on the behavior of a virtual person modeled by the generative AI.

The specific processing by the specific processing unit 290 of the data processing device 12 in Example 1 is realized by the following means.

The present invention provides a server comprising a processor and a storage unit, the processor being configured to receive goal information of a user from a user terminal via a communication interface and to store the goal information as stored information in the storage unit; to generate, in accordance with the goal information, a prompt sentence that instructs a generative artificial intelligence model to generate goal-achievement behavior of a virtual person, to input the prompt sentence into the generative artificial intelligence model through a model access interface, and to obtain, from the generative artificial intelligence model, generated text information indicating an action plan of the virtual person; to analyze the generated text information by executing parsing logic that converts the generated text information into structured action-plan information including a plurality of action elements each having at least time information, period information, category information, and description information, and to format the structured action-plan information into presentation data that is transmittable to the user terminal; to transmit the presentation data to the user terminal so that the user terminal presents, to the user, a task list or a schedule based on behavior of the virtual person; and to calculate an achievement degree of the structured action-plan information on the basis of behavior-execution status information received from the user terminal, to generate an update prompt sentence reflecting the achievement degree, to input the update prompt sentence into the generative artificial intelligence model, and to update the action plan on the basis of updated generated text information obtained from the generative artificial intelligence model. This enables the server to implement an integrated, feedback-driven processing pipeline in which user goals are transformed into machine-interpretable, structured action plans generated by a generative AI model, and in which those plans are iteratively refined based on quantified user progress, thereby improving the efficiency, reliability, and adaptability of computer-implemented goal-support processing.

The term “system” refers to an arrangement of one or more computing devices, including at least one processor, storage, and communication interface, configured to execute the processing steps described in the claims.

The term “processor” refers to one or more hardware processing units, such as a central processing unit, a graphics processing unit, a digital signal processor, or a combination thereof, that execute computer-readable instructions to perform arithmetic, logical, control, and input/output operations.

The term “storage unit” refers to one or more hardware storage resources, such as semiconductor memory, magnetic storage, or optical storage, configured to store data, programs, models, and intermediate processing results used by the processor.

The term “user” refers to a human operator who provides goal information to the system and receives presentation data, including action plans, from the system.

The term “user terminal” refers to an electronic apparatus, such as a mobile terminal, a tablet device, or a personal computing device, that communicates with the server, transmits goal information and behavior-execution status information, and displays presentation data to the user.

The term “goal information” refers to information indicating a target state or outcome desired by the user, expressed for example as natural-language text describing what the user intends to achieve within a period.

The term “stored information” refers to data that has been written to the storage unit by the processor, including at least goal information, generated text information, structured action-plan information, and behavior-execution status information.

The term “virtual person” refers to an abstract behavioral model generated by the system using a generative artificial intelligence model, the behavioral model representing actions that would be performed by a hypothetical individual attempting to achieve the user's goal.

The term “generative artificial intelligence model” refers to a machine-implemented model, such as a neural network trained on data, that receives an input including a prompt sentence and generates output data, including text, based on learned statistical relationships.

The term “prompt sentence” refers to a machine-processable instruction sequence, typically expressed in natural language, that is generated by the processor and supplied as input to the generative artificial intelligence model to specify a task, constraints, and output format.

The term “generated text information” refers to text data output by the generative artificial intelligence model in response to a prompt sentence, the text data including at least a description of behavior or an action plan of the virtual person.

The term “action plan” refers to a set of one or more actions, each associated with a time, period, category, and description, that collectively represent a procedure or schedule for achieving the user's goal.

The term “action element” refers to a minimal unit of the action plan, including at least one piece of time information, one piece of period information, one piece of category information, and one piece of description information.

The term “structured action-plan information” refers to action-plan data organized in a predefined data structure, such as records or objects, in which each action element is represented by explicit fields including at least time information, period information, category information, and description information.

The term “time information” refers to data that identifies a point in time or a time-of-day value associated with execution of an action element.

The term “period information” refers to data that identifies a duration or a temporal interval, such as a day, a week, or a longer period, associated with an action element.

The term “category information” refers to data that classifies an action element into a type, such as meal, exercise, study, rest, review, or another functional category.

The term “description information” refers to text or equivalent data that specifies the content of an action element in human-readable form.

The term “presentation data” refers to data derived from the structured action-plan information and formatted by the processor for transmission to and rendering by the user terminal, such as data suitable for display as a task list or schedule.

The term “task list” refers to a representation of one or more action elements arranged as a list, where each list item corresponds to a task derived from the structured action-plan information.

The term “schedule” refers to a representation of one or more action elements arranged along a temporal axis, such as a calendar view or timeline, indicating when each action is to be executed.

The term “behavior-execution status information” refers to data received from the user terminal indicating whether one or more action elements in the structured action-plan information have been started, partially completed, fully completed, or not executed.

The term “achievement degree” refers to a value or set of values computed by the processor based on behavior-execution status information, quantifying a level of completion or progress of the structured action-plan information relative to the goal information.

The term “update prompt sentence” refers to a prompt sentence generated by the processor based on at least the achievement degree and original goal information, the prompt sentence instructing the generative artificial intelligence model to revise or extend an existing action plan.

The term “updated generated text information” refers to generated text information output by the generative artificial intelligence model in response to the update prompt sentence, the text information representing an updated or revised action plan.

The term “model access interface” refers to software and hardware components configured to transmit prompt sentences and related parameters from the processor to the generative artificial intelligence model and to receive generated text information in return.

The term “communication interface” refers to hardware and software components that enable data exchange between the server and external devices, including the user terminal and a generative artificial intelligence service, via a communication network.

The term “behavior simulation” refers to processing by the generative artificial intelligence model in response to a prompt sentence that requests generation of a sequence of actions of the virtual person over a specified period, in order to achieve the goal information.

The term “output format” refers to structural and syntactic constraints specified in the prompt sentence to control how the generative artificial intelligence model expresses the generated text information, thereby facilitating deterministic parsing into structured action-plan information.

The term “feedback-driven processing pipeline” refers to a sequence of computer-implemented operations in which user goal information and behavior-execution status information are repeatedly processed to generate, analyze, update, and re-present action plans using the generative artificial intelligence model.

The server, the terminal, and the user cooperate in several embodiments to implement the claimed invention. In each embodiment, the server includes at least one hardware processor, a main memory, a non-volatile storage device, and a communication interface connected to a communication network. The terminal includes at least one hardware processor, a display unit, an input unit, a memory, and a communication interface. The user operates the terminal to provide goal information and to view presentation data.

In one embodiment, the server is implemented as a general-purpose computer system that uses an operating system such as a general-purpose server operating system, a web application framework such as a general-purpose web framework, and a database management system such as a relational database. The server further accesses an external generative AI service or a locally deployed generative AI model. The terminal is implemented as a mobile terminal, a tablet device, or a personal computer executing a web browser or a native application.

The server uses software modules stored in the storage unit and executed by the processor to perform the following functions: (i) a goal management module that receives and stores goal information; (ii) a prompt generation module that constructs a prompt sentence for a generative AI model; (iii) a model access module that transmits the prompt sentence to the generative AI model and receives generated text information; (iv) a parsing and structuring module that converts the generated text information into structured action-plan information; (v) a presentation formatting module that generates presentation data for the terminal; and (vi) a feedback and update module that computes an achievement degree and generates an update prompt sentence.

The terminal uses a user interface module to render screens for goal input, action-plan viewing, and progress reporting. The terminal manages local state data for user interactions, such as selected tasks or completion flags, and transmits behavior-execution status information to the server.

### 1. Hardware and Software Configuration

The server uses a multi-core central processing unit to execute program instructions, a memory subsystem to store intermediate data structures for actions and goals, and a network interface controller to send and receive messages using standard transport protocols. In a cloud-based variation, the server runs as a virtual machine instance or a containerized process in a distributed computing environment. In a local deployment variation, the server operates on an on-premise machine connected to a local network.

The server uses a database engine to maintain tables that store user identifiers, goal information, structured action-plan information, and behavior-execution status information. The goal management module defines a schema in which each record for a goal includes a normalized goal text, a start date, an end date, and a reference to user identification data. The structured action-plan information is stored as records for action elements, each record containing fields for time information, period information, category information, description information, and a foreign key to the corresponding goal.

The server uses a generative AI model that is implemented as a neural network having a sequence-to-sequence architecture, for example a transformer-type architecture with multiple self-attention layers, feedforward layers, and layer normalization. The generative AI model has been trained on large-scale text data to predict a next token in a sequence based on a context of previous tokens. The generative AI model uses floating-point matrix multiplications executed by a graphics processing unit or a specialized accelerator. The server accesses this model through a model access interface that sends the prompt sentence as a sequence of tokens, receives a sequence of output tokens, and decodes these tokens into text.

### 2. Data Processing and Technical Details

The server converts user-provided goal information into a normalized form before generating the prompt sentence. The goal management module performs operations such as Unicode normalization, whitespace trimming, and mapping of synonymous expressions to canonical representations. For example, the server maps “3 months” and “twelve weeks” to a common period representation. This normalization allows the prompt generation module to insert consistent and machine-interpretable values into the prompt sentence.

The server generates the prompt sentence according to a template that specifies both semantic content and output format constraints. For instance, for a weight-loss goal, the server generates a prompt sentence such as: “You are a virtual person who will lose 5 kilograms in 3 months in a healthy way. Please create a detailed daily action plan for 12 weeks, including specific meal menus with approximate calories and exercise schedules with time and intensity. Output the plan in a structured format, clearly separated by week and by day, and for each day list time, category, and a short description of each action.”

For a language-learning goal, the server generates a prompt sentence such as:

“Act as a virtual person who becomes fluent in everyday English conversation in 6 months. Please generate a 6-month plan that includes daily speaking practice tasks, listening practice, vocabulary and grammar study, and weekly review sessions. Output the plan in a weekly breakdown, and for each day specify the time, the category of the activity, and a concise description.”

For an examination-preparation goal, the server generates a prompt sentence such as: “You are a virtual person who will pass an intermediate-level language proficiency test in 4 months. Based on this goal, create a detailed 4-month study schedule with daily vocabulary and grammar tasks, reading and listening practice, and regular mock tests and review sessions. Output the plan with days and weeks, and for each action provide time, category, and a description.”

The server inserts explicit instructions in the prompt sentence that constrain the output format, such as specifying that each day and each action should be labeled and that time, category, and description must be clearly identifiable. Because of this, the generated text information has predictable markers that the parsing and structuring module can detect programmatically. The server thereby reduces ambiguities that would otherwise arise in plain-language outputs and reduces the number of failed parses, which directly improves computational efficiency and reliability.

The generative AI model internally represents the prompt sentence as a sequence of token embeddings, processes the embeddings through multiple attention layers, and produces a probability distribution over possible next tokens at each step. The model uses a loss function, such as cross-entropy, during training to minimize prediction error on large corpora. During inference, the model uses a decoding algorithm, such as greedy decoding or top-k sampling with temperature parameters, to generate token sequences. The server selects decoding parameters that control randomness and length, for example, by fixing a temperature value to reduce overly creative outputs that would impair parseability. The parsing and structuring module converts the generated text information into structured action-plan information. The server uses pattern-matching rules and a finite-state parser that detects delimiters such as “Week 1,” “Day 1,” and time patterns such as “07:00” or “7 am.” The server segments the text into units corresponding to action elements and assigns values to the time information, period information, category information, and description information fields. If the prompt sentence has instructed the generative AI model to output a pseudo-tabular or pseudo-list structure, the parser exploits line breaks, bullet characters, and keywords that identify categories (for example, “Meal:”, “Exercise:”, “Study:”).

The server thereby transforms unstructured natural-language outputs into normalized, structured data suitable for efficient indexing, retrieval, and manipulation using standard database operations. This structure allows the presentation formatting module to query subsets of the action elements by date, by category, or by achievement degree without expensive text searches, which improves processing speed and reduces memory overhead. The terminal renders the action-plan information based on the presentation data provided by the server. For example, the terminal displays a day-by-day list of tasks, each including the time, category, and description obtained from the structured action-plan information. The user can mark individual tasks as completed, deferred, or skipped. The terminal translates each such operation into behavior-execution status information that encodes the task identifier, the status, and a timestamp. The terminal transmits this information to the server using a structured communication protocol over a network.

The feedback and update module on the server aggregates behavior-execution status information for each goal. The server computes an achievement degree, for example, by calculating the ratio of completed tasks to scheduled tasks over a given period or by weighting certain categories of actions more heavily. The achievement degree can be represented as a numeric value or a vector that describes completion rates for different categories (for instance, meals versus exercise or vocabulary versus listening). The server stores these values in the storage unit and may generate time-series data to track progress over weeks.

The server generates an update prompt sentence that reflects the achievement degree and observed user patterns. For example, the server may generate a prompt sentence such as: “The user has completed 80 percent of the daily exercise tasks but only 40 percent of the dietary tasks during the first 4 weeks of a 12-week weight-loss plan. The user often skips evening tasks. Please revise the remaining 8 weeks of the plan so that exercise tasks are scheduled mainly in the morning and dietary tasks are simplified, while maintaining the overall healthiness of the plan. Output the updated 8-week plan in the same structured format, separated by week and day, with time, category, and description for each action.”

Because the update prompt sentence includes explicit constraints and feedback values, the generative AI model is guided to generate a revised action plan that adapts to real usage data yet remains compatible with the existing parser. The server thus implements an iterative, feedback-driven control loop in which the action plan is revised using machine-generated structure that aligns with predefined parsing rules. This loop is not a mere automation of human planning but a specialized processing pipeline optimized for machine efficiency.

### 3. Improvement of Computer Technology

The server improves computer technology in several ways. First, by automatically generating prompt sentences with explicit structural constraints, the server reduces the entropy of possible outputs from the generative AI model, leading to more predictable, parseable generated text information. This reduces the number of failed parsing attempts, the need for repeated model invocations, and the amount of manual post-processing, thereby lowering computation time and network traffic.

Second, the transformation of generated text information into structured action-plan information with explicit fields and identifiers allows the database engine to perform indexed queries rather than full-text searches. This lowers the computational complexity of retrieval operations and improves response time for rendering updated schedules on the terminal. The internal data structures are designed so that tasks can be filtered and recombined quickly by goal, date, category, or achievement degree, which directly optimizes the utilization of processing and memory resources.

Third, the server uses the achievement degree as a computed metric for feedback, which allows the processor to adapt subsequent prompts and model calls systematically. Because the server measures actual behavior-execution status at scale, the system can avoid generating unnecessarily long or detailed plans when such plans are seldom followed. The server can modify the expected length and granularity of output in the update prompt sentence, reducing the average token count generated by the model. This leads to faster model inference, lower bandwidth usage between the server and the generative AI model, and improved throughput for many users.

Fourth, the server uses a non-conventional interaction pattern with the generative AI model. Instead of a single request-response cycle, the server designs a multi-stage algorithm in which goals, prompts, outputs, and feedback are processed as a coherent data graph. This is not the way a human would typically interact with a generative AI system. The server enforces machine-oriented constraints, such as specifying label formats, indexing schemes, and stable keys used by the parser and database. These constraints are chosen specifically for computer interpretability and storage efficiency rather than for human readability alone, which demonstrates an improvement in the way computing resources cooperate with generative AI models.

Fifth, the generative AI model itself, while it may be trained using general methods such as backpropagation and gradient descent with a loss function like cross-entropy, is used in a specialized inference mode. The server applies non-default temperature, top-k, or top-p parameters based on the type of goal and the history of parsing errors for that user or that category. For instance, the server may lower the temperature for users who require strict reproducibility and raise it for users who benefit from varied exercise plans. By adjusting these parameters programmatically based on internal metrics rather than human trial-and-error, the system improves the quality and reliability of generated text information in a way that is specific to machine processing.

### 4. Alternative Embodiments and Variations

In one alternative embodiment, the server deploys the generative AI model locally rather than accessing a remote model service. In this case, the server loads model weights from the storage unit into a local accelerator device and performs inference directly. The server may use quantized weights or model distillation to reduce memory usage and latency. The data flow remains similar: the server constructs prompt sentences, tokenizes them, executes inference, decodes the output tokens, and processes the resulting text.

In another embodiment, the server uses multiple generative AI models with different capacities or specializations. For example, a smaller, faster model may be used to generate an initial plan with coarse granularity, and a larger, more accurate model may be used to refine only a subset of complex days or weeks. The server selects which model to use based on the length of the goal period, the complexity score of the goal information, or the resource load on the system. This dynamic model selection further improves computational efficiency and ensures that computing resources are used where they yield the most benefit.

In yet another embodiment, the server enriches the achievement degree computation by including timing deviations and category-specific completion rates. For example, the server may detect that a user consistently delays evening study actions by one hour and may reflect that pattern in the update prompt sentence by explicitly instructing the generative AI model to shift certain categories of actions. These adaptations are represented as numeric or categorical features in the update prompt sentence, which are then interpreted by the generative AI model as contextual cues for revising the action plan.

The terminal may also vary across embodiments. In one variation, the terminal is a wearable device, and the presentation data includes compact notifications for upcoming tasks. In another variation, the terminal is integrated with a calendar application, and the terminal maps the structured action-plan information directly into calendar entries with reminders. In each case, the terminal retains the role of providing behavior-execution status information back to the server.

The system as described therefore provides more than a business workflow or a simple automation of human planning. The server implements a specialized, feedback-driven cooperation between structured data models, a generative AI model, and a terminal interface. The technical design of the prompt sentence, the structured action-plan information, and the achievement degree, and the way they are processed by the server, yields improvements in computational efficiency, accuracy of parsing, data management, and communication efficiency. This results in a computer-implemented system that is technically distinct from conventional manual planning or simple template-based systems and that improves the functioning of the computer itself when used to support goal-oriented behavior.

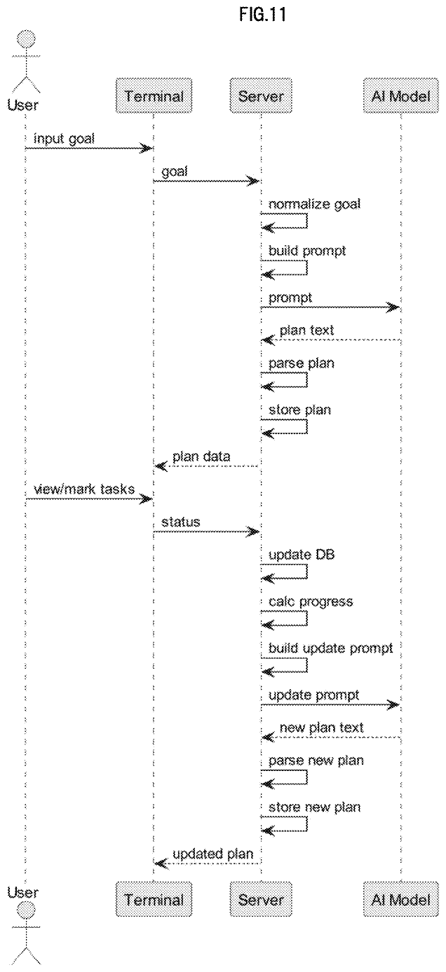

The following describes the processing flow using FIG. 11.

### Step 1

The user operates the terminal to input goal information. The terminal displays an input screen including one or more text fields and optional selectors for period and category. The input is a natural-language description of a goal, such as “I want to lose 5 kilograms in 3 months” or “I want to become fluent in English conversation in 6 months.” The terminal validates that the input field is not empty and that the length is within a predefined limit. Based on this input, the terminal generates a structured payload including a user identifier, the goal text, and optional metadata (for example, desired period and goal type), and the terminal outputs this payload as a request message transmitted to the server via a communication network.

### Step 2

The server receives the request message from the terminal. The input to this step is the structured payload containing the goal text and user identifier. The server parses the message, authenticates the user, and performs normalization on the goal text, such as trimming whitespace, converting characters to a standardized encoding, and mapping commonly used time expressions (for example, “3 months” and “twelve weeks”) to a canonical period representation. Using these operations, the server converts free-form goal text into a normalized goal record. The server then outputs a stored goal record written into a database and an in-memory representation of the normalized goal information for further processing.

### Step 3

The server analyzes the normalized goal information to determine goal attributes needed for prompt-sentence generation. The input is the in-memory normalized goal record including the goal text and canonical period. The server uses pattern matching and, optionally, a lightweight classifier to detect a goal domain (for example, diet, language learning, or exam preparation) and to extract numerical values such as target amount and duration. Based on these extracted attributes, the server computes internal feature values, such as total weeks and typical daily workload. The server outputs a goal-attribute structure that contains the goal domain, duration in days or weeks, and key numeric targets, which is used as input for constructing the prompt sentence.

### Step 4

The server generates a prompt sentence for the generative AI model using the goal-attribute structure. The input to this step is the goal-attribute structure and a set of predefined prompt templates stored in the server. The server selects an appropriate template according to the goal domain and inserts the extracted attributes into placeholder positions within the template. For example, for a weight-loss goal, the server constructs a prompt sentence such as:

“You are a virtual person who will lose 5 kilograms in 3 months in a healthy way. Please create a detailed daily action plan for 12 weeks, including specific meal menus with approximate calories and exercise schedules with time and intensity. Output the plan in a structured format, clearly separated by week and by day, and for each day list time, category, and a short description of each action.”

Through string concatenation and placeholder substitution, the server converts abstract goal attributes into a concrete, machine-processable prompt sentence. The server outputs this prompt sentence as a text string ready to be supplied to the generative AI model.

### Step 5

The server sends the prompt sentence to the generative AI model and obtains generated text information. The input is the prompt sentence text and configuration parameters for the model, such as model identifier, maximum output length, and decoding parameters (for example, temperature and top-k). The server tokenizes the prompt sentence, transmits the token sequence and parameters to the generative AI model via a model access interface, and causes the model to perform inferential computation based on its neural-network architecture. The generative AI model processes the tokens through multiple attention layers and feedforward layers and outputs a sequence of tokens representing a detailed action plan. The server decodes the token sequence back into text. The server outputs generated text information, which is a natural-language description of the virtual person's action plan, typically organized by weeks and days.

### Step 6

The server parses the generated text information into structured action-plan information. The input to this step is the generated text information output by the generative AI model. The server applies parsing rules, including detection of week and day labels, time patterns, and category keywords (for example, “Breakfast:”, “Exercise:”, “Study:”). The server uses pattern matching and a finite-state parser to segment the text into action elements and to extract, for each action element, time information, period information (such as day and week indices), category information, and description information. Based on these extracted elements, the server performs data conversion from unstructured text into a structured format, such as an array of records, where each record has explicit fields. The server outputs structured action-plan information that can be stored in the database and processed efficiently in subsequent steps.

### Step 7

The server stores the structured action-plan information and prepares presentation data for the terminal. The input is the structured action-plan information, which includes multiple action elements associated with a specific goal. The server writes the structured action elements into one or more database tables, linking each element to the corresponding goal and user by identifiers. The server then performs a formatting operation in which it groups action elements by day or week, computes summary information (such as number of tasks per day and total planned time per category), and embeds these grouped structures into a presentation-oriented data object. The server outputs presentation data tailored for client rendering, including a daily or weekly schedule that the terminal can display directly.

### Step 8

The server transmits the presentation data to the terminal, and the terminal renders the action plan for the user. The input to this step on the server side is the presentation data object, and the output is a response message containing the presentation data sent via a communication interface to the terminal. Upon receiving this message, the terminal parses the presentation data, creates internal UI models representing days, tasks, and categories, and maps each action element to visual components such as list items or calendar cells. The terminal uses data from the presentation data object, including time, category, and description, to generate a user interface layout. The terminal outputs a rendered view on the display unit that shows the virtual person's action plan as a task list or schedule.

### Step 9

The user reviews the presented action plan on the terminal and interacts with individual tasks. The input to this step is the displayed schedule comprising tasks derived from the structured action-plan information. The user reads the descriptions, adjusts personal activities, and uses input operations such as tapping or clicking to mark tasks as completed, skipped, or postponed. The terminal converts each user interaction into behavior-execution status information that includes identifiers of the affected action elements, the new status values, and timestamps. The terminal outputs this behavior-execution status information as structured update messages to the server.

### Step 10

The server receives the behavior-execution status information and updates stored records. The input to this step is the update message containing status changes for one or more action elements. The server parses the message, identifies each corresponding action element in the database by its identifier, and updates the stored status field (for example, from “scheduled” to “completed” or “skipped”). The server may also log historical status changes for analysis. Using these updated records, the server computes intermediate statistics such as daily completion counts and category-specific completion rates. The server outputs updated database records and preliminary progress metrics that serve as the basis for calculating an overall achievement degree.

### Step 11

The server calculates an achievement degree based on the updated action-plan information and behavior-execution status information. The input is the set of action elements associated with a goal and their current status values. The server applies a predefined algorithm that, for example, divides the number of completed tasks by the total number of scheduled tasks within a certain time window, optionally weighted by category or importance. The server may compute one or more numeric indicators, such as overall completion percentage and separate completion rates for certain categories. Through these arithmetic operations, the server converts multiple status records into compact numeric or vector-based representations of progress. The server outputs an achievement-degree value or vector that is associated with the goal.

### Step 12

The server generates an update prompt sentence using the achievement degree and the original goal information. The input is the achievement-degree value, the stored goal information, and optionally a history of previous revisions. The server constructs a new prompt sentence that describes the observed progress and requests the generative AI model to revise the remaining portion of the plan. For example, the server creates a prompt sentence such as:

“The user has completed 80 percent of the daily exercise tasks but only 40 percent of the dietary tasks during the first 4 weeks of a 12-week weight-loss plan. The user often skips evening tasks. Please revise the remaining 8 weeks of the plan so that exercise tasks are scheduled mainly in the morning and dietary tasks are simplified, while maintaining the overall healthiness of the plan. Output the updated 8-week plan in the same structured format, separated by week and day, with time, category, and description for each action.”

The server integrates numeric progress values into explanatory phrases or structured conditions inside this prompt sentence. The server outputs the update prompt sentence as text ready for a subsequent call to the generative AI model.

### Step 13

The server sends the update prompt sentence to the generative AI model and updates the action plan based on the model's new output. The input is the update prompt sentence and model configuration parameters, and, optionally, information about which days or weeks of the plan should be revised. The server performs tokenization, transmits the tokenized update prompt to the generative AI model, and receives new generated text information that describes a revised action plan for the remaining period. The server parses this new generated text using the same parsing and structuring procedures as in earlier steps, then replaces or augments the corresponding action elements in the database for the remaining days or weeks. The server outputs updated structured action-plan information and new presentation data, which can be sent back to the terminal for display to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems typically analyze static user profile information, past purchase histories, or simple preference indicators to output recommended items or services. Such systems generally rely on fixed rule sets or conventional machine learning models that map from user attributes to item attributes. As a result, these systems are limited in their ability to generate context-rich, goal-oriented guidance and cannot dynamically simulate user behavior over time toward a specific objective. In particular, when a user has a future-oriented personal goal, such as improving health, changing lifestyle, or adopting environmentally conscious behaviors, conventional systems fail to generate detailed, temporally-structured action sequences and to connect those sequences to concrete items or services in a way that is both adaptive and understandable to the user.

Furthermore, typical systems that interface with generative AI models treat the model as a simple text completion engine: they send unstructured prompts, receive unstructured text, and present that text directly to the user. Such architectures do not leverage the generative AI output as structured, machine-usable data that can feed downstream computational processes such as keyword extraction, catalog search, relevance scoring, and iterative plan refinement. Consequently, the server-side computation is not optimized to exploit the strengths of generative AI models, and the overall computer system remains inefficient, brittle, and difficult to scale or audit.

Additionally, known interfaces to generative AI models usually do not enforce robust prompt structuring, section separation, or explicit behavioral segmentation. Without a mechanism to generate and enforce structured prompt sentences, the server cannot reliably obtain output that separates behavioral descriptions from item or service suggestions. This lack of structure hinders automated parsing and prevents the system from effectively using the generative output as input to subsequent search and recommendation algorithms. The result is increased processing overhead, ad hoc parsing logic, and inconsistent user experience.

Another problem in existing systems is the absence of a closed feedback loop between user interaction and generative AI-driven planning. Conventional systems present recommendations as a one-shot output with limited ability to refine or personalize an action plan based on user selections. There is often no server-level mechanism to capture the user's chosen behaviors or items and then generate a more detailed, time-based action plan via re-prompting of the generative AI model. This leads to underutilization of computing resources and prevents dynamic adaptation of the plan to the user's evolving preferences or constraints. Accordingly, there is a need for an improved computer-implemented system and server architecture that: (i) programmatically constructs structured prompt sentences based on user goal information, (ii) obtains generative AI model output in a form that can be treated as structured data, (iii) performs automated extraction of behavior keywords and machine-executable search operations over item and service data sets, and (iv) implements an iterative feedback loop that generates refined action plans based on explicit user selections. Such a system should enhance the technical functioning of the computer by improving data structuring, query generation, and interaction management between the server, the user terminal, and the generative AI model, thereby increasing efficiency, reliability, and scalability of goal-oriented recommendation processing.

The specific processing by the specific processing unit 290 of the data processing device 12 in Application Example 1 is realized by the following means.

The present invention provides a server comprising a processor, a storage device, a communication interface, and a generative AI model interface, wherein the processor is configured to: receive, via the communication interface, goal information of a user from a user terminal over a communication network and store the goal information in the storage device; generate, based on the goal information, a structured prompt sentence that instructs a generative AI model to output behavior information of a virtual person and item information or service information in mutually distinguishable sections, and provide the structured prompt sentence to the generative AI model through the generative AI model interface; obtain, from the generative AI model, output information including the behavior information of the virtual person and the item information or the service information, and analyze the output information as structured data including heading information and list information; extract, from the structured data, one or more behavior keywords representing behaviors of the virtual person, and search, in a data set stored in the storage device, one or more candidate items or one or more candidate services associated with the one or more behavior keywords by executing computerized search operations; generate recommendation information in which the behaviors of the virtual person and the one or more candidate items or the one or more candidate services are associated with each other in a machine-readable format, and transmit the recommendation information to the user terminal so that the user terminal presents the behaviors and the one or more candidate items or the one or more candidate services as selectable options; receive, from the user terminal, selection information indicating one or more behaviors or one or more candidate items or one or more candidate services selected by the user based on the recommendation information; generate, based on the selection information and the stored goal information, a further structured prompt sentence that instructs the generative AI model to output an action plan including temporally-organized tasks for achieving the goal of the user, provide the further structured prompt sentence to the generative AI model, obtain, from the generative AI model, output information including the action plan, and transmit the output information including the action plan to the user terminal so that the action plan is presented to the user. This enables the server to improve computer functionality by transforming unstructured user goal input into structured, machine-parseable generative AI output, by automatically linking behavior-level descriptions to searchable item and service data through server-side keyword extraction and search processing, and by establishing an iterative, computational feedback loop in which user selections drive the generation of refined, time-based action plans, thereby enhancing processing efficiency, scalability, and reliability of goal-oriented recommendation and planning operations implemented on the computer system.

The term “system” refers to a combination of hardware and software components including at least one processor, a storage device, a communication interface, and a generative AI model interface configured to cooperate to perform the claimed processing.

The term “processor” refers to one or more hardware processing units, such as a central processing unit or a graphics processing unit, capable of executing machine-readable instructions to perform the claimed functions.

The term “storage device” refers to one or more non-transitory computer-readable media, such as a magnetic disk, a solid-state drive, or a semiconductor memory, that store data and programs used by the processor.

The term “communication interface” refers to hardware and software elements that enable data exchange between the system and external devices or networks, such as a network interface card, a wireless communication module, or a modem.

The term “generative AI model interface” refers to hardware and software components configured to send prompt sentences to a generative AI model and to receive output information from the generative AI model via a communication path.

The term “generative AI model” refers to a machine learning model, such as a neural network language model, that is configured to generate output data including natural language text in response to input data including a prompt sentence.

The term “user” refers to a human individual who provides goal information to the system and receives recommendation information or an action plan from the system.

The term “user terminal” refers to an electronic device operated by the user, such as a smartphone, a tablet, or a personal computer, that communicates with the system via the communication interface.

The term “goal information” refers to data representing a target, intention, or objective of the user, such as a lifestyle change, a health goal, or another desired future state.

The term “virtual person” refers to a digital representation of an individual generated by the generative AI model, the digital representation being associated with behaviors that aim to achieve the goal information of the user.

The term “behavior information” refers to data describing actions, activities, or routines of the virtual person, including daily, weekly, or other temporally-organized behaviors.

The term “item information” refers to data describing tangible or intangible items, such as products, goods, or digital content, including attributes such as a name, a category, and a price.

The term “service information” refers to data describing services provided to the user, such as subscriptions, consulting, or online offerings, including attributes such as a service name, a type, and usage conditions.

The term “data set” refers to a collection of item information and/or service information stored in the storage device and searchable by the processor.

The term “prompt sentence” refers to an instruction string or structured textual input that is generated by the processor and provided to the generative AI model to control the content and format of output information.

The term “structured prompt sentence” refers to a prompt sentence that includes predefined sections, headings, or formatting rules that instruct the generative AI model to output information in separated or distinguishable parts, such as behaviors and item or service suggestions.

The term “output information” refers to data generated by the generative AI model in response to a prompt sentence, including at least behavior information of the virtual person and optionally item information or service information.

The term “structured data” refers to output information that is organized according to identifiable elements such as headings, lists, or labeled sections, enabling the processor to parse and analyze the information programmatically.

The term “heading information” refers to text segments within the output information that indicate section titles or labels, such as a heading for behaviors or a heading for item or service suggestions.

The term “list information” refers to output information organized as a sequence of elements, such as bullet points or numbered items, each describing a behavior, an item, or a service.

The term “behavior keyword” refers to a word or phrase extracted from the behavior information that represents an action, an activity, or a concept associated with the behavior of the virtual person.

The term “candidate item” refers to an item selected by the processor from the data set based on a correspondence between item information and one or more behavior keywords.

The term “candidate service” refers to a service selected by the processor from the data set based on a correspondence between service information and one or more behavior keywords.

The term “recommendation information” refers to data that associates behaviors of the virtual person with one or more candidate items or one or more candidate services, and that is configured to be presented to the user as recommendations.

The term “selection information” refers to data received from the user terminal indicating one or more behaviors, one or more candidate items, or one or more candidate services that have been selected by the user.

The term “action plan” refers to structured information generated by the generative AI model that describes temporally-organized tasks or steps to be performed by the user to achieve the goal information.

The term “user interface information” refers to data generated by the processor that defines how behaviors, candidate items, or candidate services are to be displayed or presented on the user terminal, including selectable options.

In one embodiment, a server cooperates with a terminal and a generative AI model to implement the claimed system. The server includes at least one processor, a main memory, a non-transitory storage device such as a solid-state drive, and a communication interface such as an Ethernet or wireless network adapter. The terminal includes a processor, a display unit, a user input unit such as a touch panel or keyboard, a memory, and a communication module. The generative AI model executes on a computing platform including one or more graphics processing units or tensor processing units. The server and the generative AI model communicate via a network using an application programming interface.

The server stores in the storage device a plurality of software modules, such as a web application module, an API module, a data management module, a prompt generation module, an AI interaction module, a parsing and structuring module, a keyword extraction module, a search and ranking module, and a user interface generation module. The server loads these modules into the main memory and executes them on the processor. The server also stores in the storage device a relational database containing user records, goal information records, product or item records, service records, recommendation records, and action plan records.

The server uses an operating system, a web server framework, a relational database management system, and a client library for accessing the generative AI model. The terminal executes a web browser or a native application to present user interface screens and to exchange data with the server. The generative AI model is implemented as a transformer-based neural network having a plurality of encoder and decoder layers, multi-head self-attention mechanisms, and feed-forward sub-layers, and is trained on a large corpus of text data using supervised learning and, optionally, reinforcement learning from feedback signals. The server uses the storage device to maintain goal information as structured records. The server stores each goal as a text field, together with a user identifier, a language code, timestamps, and status flags indicating processing stages. The server also stores a catalog of item information and service information, each with fields such as identifier, category, textual description, tags, price, and URL. The server defines data structures for recommendation information, including references to goal identifiers, behavior entries, and candidate item or candidate service entries.

The server uses the prompt generation module to create a prompt sentence by embedding goal information into a predetermined template. The server generates different templates for different purposes, such as generating initial behavior information of a virtual person, generating item or service suggestions, or generating a detailed action plan. The server applies deterministic string concatenation and formatting rules so that each generated prompt sentence contains explicit section labels and output format instructions.

In one example, the server generates the following prompt sentence based on goal information corresponding to an eco-friendly lifestyle:

“You are a virtual person representing a user.

The user's goal is: ‘I want to achieve an eco-friendly lifestyle.’

1. As the virtual person, describe your specific daily and weekly behaviors that help achieve this goal.

2. Based on these behaviors, list specific products and services that support this eco-friendly lifestyle (for example, reusable items, public transportation passes, green energy plans, eco-friendly cleaning products).

Please answer in English and separate the sections with the headings ‘Behaviors’ and ‘Product and Service Suggestions’.”

The server provides the prompt sentence to the generative AI model via the generative AI model interface. The generative AI model receives tokenized representations of the prompt sentence, applies multiple layers of self-attention and feed-forward transformations, and computes an output token sequence that represents behavior information and item or service suggestions. The generative AI model uses learned weight matrices, bias parameters, positional encodings, and activation functions such as rectified linear units or variants thereof. The generative AI model has been trained using stochastic gradient descent or an adaptive optimization algorithm, such as Adam, to minimize a cross-entropy loss between predicted tokens and ground-truth tokens during a training phase. The generative AI model updates internal weights by backpropagating errors and applying weight updates in each training iteration. The generative AI model can also incorporate fine-tuning using domain-specific texts and reinforcement learning from preference data to adjust output style and structure.

The server receives the output information from the generative AI model and stores it in the storage device as raw text associated with the corresponding goal information. The server uses the parsing and structuring module to identify heading information and list information in the output. The server uses deterministic rules to locate headings such as “Behaviors” and “Product and Service Suggestions” and to split the text into sections. The server uses pattern matching, whitespace normalization, line break normalization, and numbering detection to generate structured data objects, each object including a heading field and a list of entries. The server uses the keyword extraction module to extract behavior keywords from the behavior entries. The server applies tokenization, lemmatization, and part-of-speech tagging to the text of each behavior entry. The server uses a domain-specific keyword dictionary and scoring rules that give higher weights to nouns and noun phrases and lower weights to function words. The server may use term frequency-inverse document frequency scores calculated over a corpus of behavior descriptions stored in the storage device to select salient terms. The server thereby generates behavior keyword sets for each goal.

The server uses the search and ranking module to query item and service records based on the behavior keywords. The server converts each behavior keyword into one or more query tokens and uses structured queries to search the database. The server uses SQL queries that match keywords against item or service descriptions, tags, or categories. The server calculates relevance scores using a linear combination of factors such as keyword overlap, category similarity, and prior usage statistics. The server optionally uses a vector representation of item descriptions and behavior descriptions, computed using pre-trained embeddings, to calculate similarity scores with cosine similarity. The server ranks candidate items and candidate services based on these scores.

The server uses the user interface generation module to generate recommendation information that associates each behavior entry with one or more candidate items or candidate services. The server stores the recommendation information as structured data including behavior identifiers, lists of associated candidate identifiers, ranks, and metadata. The server creates user interface descriptions that specify layout elements, such as headings, behavior sections, and selection controls, and transmits the recommendation information and the user interface descriptions to the terminal.

The terminal receives the recommendation information and renders it on the display unit. The terminal uses a graphical user interface library or framework to display behavior sections and associated item or service options. The terminal enables user interaction by providing selection controls such as checkboxes or buttons. The user can select one or more behaviors to adopt, and one or more items or services of interest, using the input unit. The terminal collects these selections and sends selection information to the server.

The server uses the selection information and the associated goal information to generate a further prompt sentence. The server embeds identifiers and text descriptions of selected behaviors and items or services into a template that instructs the generative AI model to output an action plan. In one example, the server generates the following prompt sentence: “You are a virtual person representing a user with the goal: ‘I want to achieve an eco-friendly lifestyle.’

The user has chosen the following behaviors:

1. Carry a reusable stainless-steel bottle.

2. Use reusable shopping bags.

Based on these chosen behaviors, please create a concrete 4-week action plan with weekly tasks and short daily tips to help the user adopt these behaviors.

Please answer in English and structure your response into sections for Week 1, Week 2, Week 3, and Week 4.”

The server provides this further prompt sentence to the generative AI model and obtains output information that describes an action plan with temporally-organized tasks. The server parses the action plan output using rules similar to those used for behavior information, identifies week labels and daily tips, and stores the action plan as structured data. The server then sends the action plan to the terminal. The terminal presents the action plan as a timeline, checklist, or calendar view, enabling the user to track progress. The terminal may store local copies of the plan for offline viewing and may notify the user at pre-defined times.

The server configures the modules and data structures in such a way that the generative AI model outputs are consistently structured and parseable. By enforcing explicit section labels through the prompt sentences, the server reduces ambiguity and simplifies parsing logic. This structured processing improves computational efficiency because the server performs direct extraction of behavior entries and item or service suggestions without relying on heuristic or ad hoc parsing. The server thereby reduces processing time and memory usage for each recommendation cycle.

The server improves search accuracy by using behavior keywords extracted from the generative AI output rather than directly using raw user goal text. Because the behavior keywords represent concrete actions and contexts derived from the virtual person's perspective, the server can match products and services more precisely to user needs. This reduces false positives in recommendations and lowers the number of database queries required to achieve a high-quality result. The server also improves ranking quality by combining keyword-based relevance with similarity scores from embedding space representations.

The server improves data management by storing prompt sentences, raw generative outputs, structured sections, and recommendation information in distinct, linked tables. This modular data structure enables traceability and auditability, allowing the server to reconstruct how each recommendation was derived from given goal information and prompt sentences. The server can reuse stored prompt and output pairs to refine templates and update ranking parameters over time, leading to iterative improvement in system performance.

The server improves communication efficiency by structuring the data exchanged with the terminal and the generative AI model. Between the server and the generative AI model, the server transmits only prompts and receives only structured text outputs, avoiding transmission of large, unstructured data sets. Between the server and the terminal, the server sends compact structured recommendation information and action plans instead of free-form texts. This reduces bandwidth usage and latency in interactive sessions.

The server implements processing sequences and data transformations that differ from conventional manual planning or simple automation of human decision-making. The server constructs virtual person behaviors through trained generative modeling, extracts machine-usable behavior keywords, and uses these keywords to perform algorithmic searches and rankings that are not feasible through manual processes at similar speed or scale. The server executes non-conventional rules by dynamically generating structured prompt sentences that enforce formats on the generative AI output, and by tightly coupling this output to subsequent computational steps in the server, such as keyword extraction and search.

The generative AI model uses internal attention mechanisms that assign different weights to different parts of the prompt sentence and previously generated tokens. The model internally computes attention weight matrices and applies them to value vectors to focus processing on contextually important parts of the prompt. This internal structure allows the model to output coherent, multi-section responses that respect the structuring instructions in the prompt sentences. The server exploits these internal behaviors by designing prompt sentences that explicitly request headings, sections, and ordered lists, thereby improving the consistency and predictability of outputs.

The server can implement variations of the generative AI model, such as models with differing numbers of layers, hidden dimensions, attention heads, or vocabulary sizes. The server can manage model parameters such as maximum token counts, temperature, top-k or top-p sampling parameters, and penalty terms for repetition. By adjusting these parameters, the server can trade off between diversity and determinism in the outputs, thereby tuning the system for either exploration of new behavioral options or consistency of action plan generation.

In another embodiment, the server uses a locally deployed generative AI model on its own hardware. The server loads model weights from the storage device into GPU memory and executes inference routines on the local processor units. The server then avoids external network latency and can exert fine control over memory management, batching of inference calls, and resource allocation. This local deployment can improve response times and reduce communication overhead, particularly in environments with strict latency requirements. In yet another embodiment, the server uses different prompt templates depending on the category of the goal information. The server maintains a mapping from goal categories, such as health, finance, education, or environment, to specialized templates that request domain-specific behaviors and item or service suggestions. The server may use a classification algorithm executed on the processor to assign goal categories based on the content of the goal information. The classification algorithm may use features such as n-gram frequencies and pre-trained embeddings and may be implemented using a logistic regression model, a decision tree model, or a shallow neural network. By selecting a template appropriate to the goal category, the server can improve the relevance of behaviors and items or services suggested by the generative AI model and thereby increase recommendation precision. In a further embodiment, the server implements caching mechanisms. The server stores in the storage device the relationship between goal information and previously generated behavior information and action plans. When the server receives new goal information similar to stored goal information, the server can reuse stored structured outputs instead of invoking the generative AI model. The server may use similarity measures between goal texts, such as cosine similarity of text embeddings, to determine whether to use cached outputs. This caching reduces the number of generative AI calls, lowers computational cost, and shortens response times, thereby improving overall system efficiency.

The terminal may also implement variations in presentation, such as voice-based interfaces. The terminal may convert behavior entries and action plan steps into audio by using a text-to-speech engine. The terminal may accept user responses via voice recognition and send structured selection information back to the server. These variations do not change the fundamental server-side processing logic but provide different user interaction modes. Through the above architectures, modules, and data flows, the server uses the generative AI model in a manner that enhances computer technology. The server transforms unstructured human-provided goal information into structured representations of virtual person behaviors, uses those representations to perform efficient database searches, and iteratively refines action plans based on user selections. The server thereby improves processing speed by reducing the complexity of parsing and search operations, improves accuracy by basing recommendations on detailed behavioral contexts, and improves data management by maintaining structured, linked records across multiple processing stages.

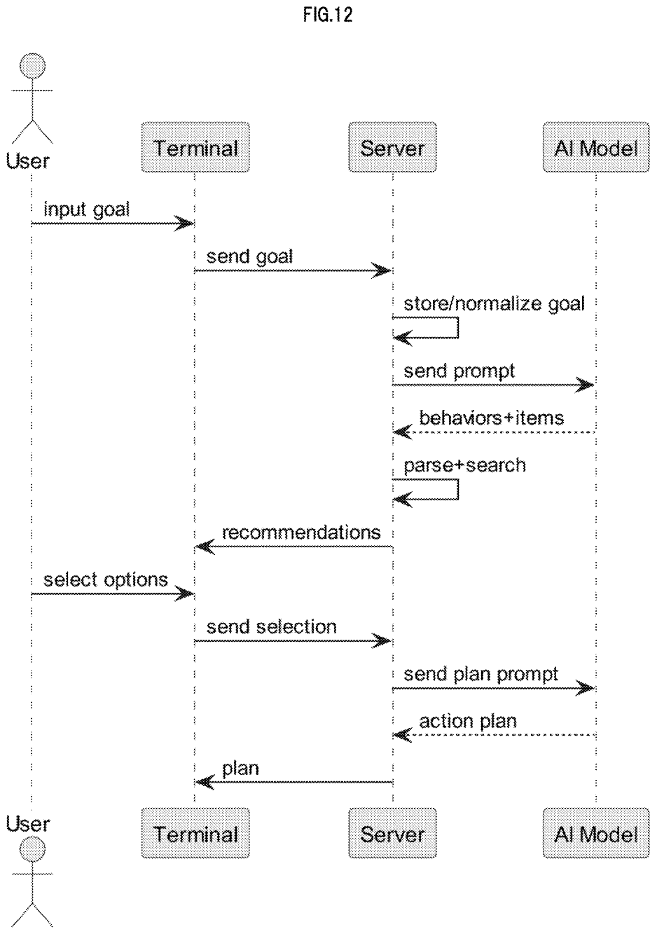

The following describes the processing flow using FIG. 12.

### Step 1

User operates the terminal to input goal information.

User views, on the terminal display, an input screen that includes a text field labeled with a request such as “Please enter your goal.”

User types a goal sentence, for example, “I want to achieve an eco-friendly lifestyle,” and confirms the input by pressing a send button.

Terminal receives the text as input data, performs client-side validation (for example, checks that the length is within a preset range), and constructs a structured message including at least a user identifier and the goal text.

Terminal converts this structured message into a request payload and outputs the payload to the communication module for transmission to the server.

### Step 2

Server receives the goal information from the terminal.

Server accepts, via the communication interface, a network request that includes the user identifier and the goal text as input data.

Server parses the request, decodes any transport encoding (such as JSON), and validates that mandatory fields are present.

Server stores the received goal text and associated metadata (user identifier, timestamp, language code if available) into a goal record in a database table.

Server outputs a stored goal identifier and normalized goal text as intermediate data for subsequent processing.

### Step 3

Server normalizes and annotates the goal information.

Server uses the stored goal text as input and applies text preprocessing operations such as lowercasing, trimming whitespace, and removing redundant line breaks.

Server optionally performs language detection and simple tokenization using a text-processing library, and stores annotations such as detected language and token count.

Server may compute basic statistics, for example, length in characters and words, and flags goals that exceed predefined thresholds.

Server updates the goal record with these normalized and annotated fields and outputs a cleaned goal text string suitable for prompt generation.

### Step 4

Server categorizes the goal to select an appropriate prompt template.

Server takes the normalized goal text as input and applies a classification routine, such as keyword matching or a lightweight classifier, to assign a goal category (for example, “environment,” “health,” or “finance”).

Server uses a mapping from categories to prompt templates to select a template that defines sections, headings, and requested output structure for the generative AI model.

Server writes the determined category and template identifier back to the goal record and outputs the selected template together with the normalized goal text.

### Step 5

Server generates a structured prompt sentence for the generative AI model.

Server takes as input the normalized goal text and the selected template, and applies deterministic string concatenation and variable substitution.

Server embeds the user's goal text into the template at designated insertion points and ensures that specific headings and numbered instructions are present.

Server thereby generates a structured prompt sentence that explicitly instructs the generative AI model to output separate sections for behaviors and product or service suggestions.

Server stores the generated prompt sentence in a prompt log and outputs the prompt sentence as input to the generative AI interaction.

### Step 6

Server sends the prompt sentence to the generative AI model and requests output.

Server receives the prompt sentence as input and constructs a model request that defines model parameters, such as model name, maximum output length, and sampling settings.

Server converts the prompt sentence and parameters into a request format accepted by the generative AI model interface.

Server transmits the request over a network connection to a computing platform that hosts the generative AI model.

Server outputs a pending request identifier and waits for output information from the generative AI model.

### Step 7

Generative AI model generates behavior information and item or service suggestions.

Generative AI model receives, as input, a tokenized representation of the prompt sentence and internal configuration parameters such as temperature and maximum tokens.

Generative AI model processes this input through multiple neural network layers that apply attention weights and non-linear transformations to compute probability distributions over output tokens.

Generative AI model sequentially samples output tokens to construct output text that contains at least a “Behaviors” section and a “Product and Service Suggestions” section.

Generative AI model returns the generated output text as output information to the server via the generative AI model interface.

### Step 8

Server receives and stores the raw output from the generative AI model.

Server obtains, from the generative AI model interface, the generated output text as input data and associates it with the corresponding prompt sentence and goal identifier.

Server writes the raw output text, along with metadata such as model identifier and generation timestamp, into an output record in the database.

Server verifies that the output contains at least some text and flags missing or truncated outputs for potential re-generation.

Server outputs the raw output text as input to the parsing and structuring process.

### Step 9

Server parses the output text into structured sections.

Server takes the raw output text as input and searches for predefined headings, such as “Behaviors” and “Product and Service Suggestions,” using string matching.

Server splits the text into sections at heading boundaries, removes extraneous header markers, and normalizes line breaks within each section.

Server further divides each section into list items by detecting bullets, numbers, or line delimiters, thereby constructing arrays of behavior entries and item or service suggestion entries.

Server stores these structured arrays in the database and outputs a structured data object containing behavior entries and suggestion entries.

### Step 10

Server extracts behavior keywords from the behavior entries.

Server uses the list of behavior entries as input and applies tokenization and part-of-speech tagging to each entry.

Server filters tokens to keep mainly nouns and noun phrases and uses a domain-specific dictionary or term frequency statistics to score candidate keywords.

Server selects a subset of tokens as behavior keywords for each behavior entry, for example, phrases like “reusable bottle,” “shopping bags,” or “public transportation.”

Server stores extracted behavior keywords linked to corresponding behavior entries and outputs a keyword list as input for search and ranking.

### Step 11

Server searches item and service data sets using behavior keywords.

Server takes as input the behavior keyword list and the stored catalog of item and service records.

Server constructs search queries for each keyword and executes structured queries against the catalog, matching keywords against fields such as item descriptions, tags, and categories.

Server retrieves candidate item and service records that satisfy matching conditions and computes relevance scores, for example, based on the number of matching keywords and field weights.

Server stores the mapping from behavior entries to candidate items or candidate services and outputs ranked candidate lists for recommendation generation.

### Step 12

Server generates recommendation information linking behaviors to candidate items and services.

Server receives as input the structured behavior entries and the ranked candidate lists from the search process.

Server pairs each behavior entry with one or more top-ranked candidate items or services and creates recommendation structures that contain behavior text, item or service identifiers, and ranking data.

Server compiles these structures into a recommendation package associated with the original goal identifier and prepares them for transmission to the terminal.

Server outputs the recommendation package as a data object including all behavior-item/service associations.

### Step 13

Server generates user interface information for presenting recommendations.

Server uses the recommendation package as input and builds user interface descriptions, such as layout definitions that specify section titles, behavior blocks, and selectable item or service options.

Server assigns unique identifiers to interactive elements, such as selection buttons, to allow the terminal to attach user actions to specific behaviors or items.

Server encapsulates these descriptions together with the recommendation package into a response message suitable for the terminal.

Server outputs the response message, including recommendation and user interface information, to the communication interface for delivery to the terminal.

### Step 14

Terminal presents the behaviors and recommendations to the user.

Terminal receives the response message from the server as input and parses the included recommendation information and user interface descriptions.

Terminal constructs display elements, such as headings for “Virtual Person Behaviors” and lists of associated products and services, and renders them on the display unit.

Terminal creates interactive controls (for example, buttons or checkboxes) based on identifiers provided by the server so that user selections can be captured accurately.

Terminal outputs a fully rendered screen where the user can view behaviors and corresponding candidate items or services.

### Step 15

User reviews behaviors and selects actions or items.

User observes the list of behaviors and associated candidate products or services displayed on the terminal.

User evaluates the relevance of each behavior and each option and then operates the input unit to select behaviors to adopt, and optionally candidate items or services of interest.

User confirms the selections by pressing a confirmation control provided by the terminal.

Terminal captures these user choices and outputs selection information representing the user's decisions.

### Step 16

Terminal sends selection information to the server.

Terminal converts the captured selections into a structured message that includes references to the goal identifier, selected behavior identifiers, and selected item or service identifiers.

Terminal validates the message format and ensures that it includes all required fields before transmission.

Terminal transmits the selection information through the communication module to the server.

Terminal outputs a status indicating that the selection has been sent and may display a waiting indicator while further processing occurs on the server.

### Step 17

Server generates a further prompt sentence for an action plan.

Server receives the selection information as input and retrieves the corresponding goal information and behavior entries from the database.

Server composes a new template for an action plan that includes temporal structure, such as weekly breakdowns and daily task instructions.

Server embeds the selected behaviors and the original goal description into this template, generating a further prompt sentence that explicitly requests an action plan with specified sections and timeframes.

Server stores this further prompt sentence and outputs it as input to the generative AI model interface.

### Step 18

Server sends the further prompt sentence to the generative AI model and obtains an action plan.

Server takes the further prompt sentence as input and constructs a second model request similar in format to the initial one, possibly using different generation parameters suitable for plan detail.

Server sends this request to the generative AI model and awaits a response.

Generative AI model processes the further prompt sentence and generates output text that includes an action plan organized into temporal segments (for example, “Week 1,” “Week 2,” and so on).

Server receives the action plan text as output from the generative AI model interface.

### Step 19

Server structures and stores the action plan.

Server uses the action plan text as input and applies parsing rules to detect temporal headings and individual task entries.

Server splits the text into sections corresponding to time intervals and further divides each section into daily or task-level entries.

Server stores the action plan as structured data objects linked to the goal identifier and the user identifier, including fields for time segments, task descriptions, and optional reminders.

Server outputs a structured action plan object for delivery to the terminal.

### Step 20

Server sends the structured action plan to the terminal.

Server prepares a response message that includes the structured action plan and user interface descriptions specifying how to display the plan, such as lists, timelines, or calendar-like views.

Server transmits this response message to the terminal through the communication interface.

Server may update internal status fields to indicate that an action plan has been generated for the corresponding goal.

Server outputs a confirmation that the plan has been dispatched to the terminal.

### Step 21

Terminal presents the action plan to the user.

Terminal receives the action plan message from the server as input and parses its structure and layout instructions.

Terminal renders each temporal section of the plan as a separate visual block, showing weekly or daily tasks with checkable or markable status indicators.

Terminal may store the plan locally in memory for offline reference and may configure local notification mechanisms to alert the user when tasks become due.

Terminal outputs an interactive plan view that allows the user to track progress and refer back to recommended behaviors and associated items or services.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional goal-support systems and coaching applications primarily present static checklists, generic advice, or pre-authored scenarios that are only loosely tailored to a user's goal. Even when such systems incorporate a generative AI model, the model is typically invoked in a one-shot manner to output narrative guidance, without tightly integrating the generated content into a machine-tractable, updatable control flow. As a result, the computing device merely displays text output, and cannot effectively transform such output into structured schedules, numerical plans, feedback loops, or adaptive behavior over time.

In particular, existing systems lack mechanisms by which a processor: (i) converts natural-language goal information into prompt sentences that cause a generative AI model to synthesize a “virtual entity” representing a successful future self of the user; (ii) parses the resulting natural-language description into structured action plan information containing time, quantity, and action-type fields; (iii) performs numerical computations over this structured data to compute indices such as action amount, load level, or achievement degree for a given period; and (iv) continuously updates both the prompts and the generated plans in response to actual action information from the user. Without such a closed-loop architecture, the system cannot use the generative AI model as an integral computational component that drives iterative plan refinement, but instead uses it as a mere text generator, which limits both usability and the technical effectiveness of the system.

Furthermore, conventional user guidance systems do not systematically generate notification scheduling information directly from structured plans derived from generative AI output. They also fail to integrate heterogeneous information sources—such as user goal information, user attribute information, and user action history—into dynamically reconstructed prompt sentences. This prevents fine-grained control over the behavior of the generative AI model and reduces the ability of the system to provide computationally optimized, context-aware action options that adapt to the user's progress.

Accordingly, there is a need for a computer-implemented technique in which a processor coordinates storage, prompt construction, generative AI inference, structured plan generation, numerical evaluation, notification scheduling, and plan updating in a unified feedback loop, thereby improving the way a computer processes and utilizes generative AI output for user-guidance tasks. The objective of the present invention is to provide a system that implements such a loop to more efficiently convert high-level goal information into actionable, adaptive schedules, while improving the accuracy, structure, and responsiveness of computer-based planning and guidance.

The specific processing by the specific processing unit 290 of the data processing device 12 in Example 2 is realized by the following means.

The present invention provides a server comprising a processor and a storage device, the processor being configured to acquire goal information of a user and store the goal information as storage information in the storage device; to construct, on the basis of the goal information and the storage information, a prompt sentence for causing a generative AI model to generate behavioral characteristics of a virtual entity, and to input the prompt sentence to the generative AI model; to analyze behavioral information regarding the virtual entity output from the generative AI model, to extract time information, quantity information, and action-type information from the behavioral information, and to generate structured action plan information; to perform numerical computation on the basis of the action plan information to calculate an index regarding an amount of actions, a load amount, or a degree of achievement in a predetermined period, and to correct the action plan information on the basis of a result of the numerical computation; to transmit the corrected action plan information to a user terminal and to cause the user terminal to present the corrected action plan information as a schedule of actions on a daily basis or a weekly basis; to acquire actual action information of the user via the user terminal and to update the action plan information on the basis of the actual action information; to reconstruct, on the basis of the updated action plan information and at least one of the goal information and attribute information of the user, the prompt sentence for the generative AI model and to cause the generative AI model to regenerate the virtual entity and the action plan information; and to generate notification time information for each action item on the basis of the structured action plan information and transmit the notification time information and a notification message corresponding to each action item to the user terminal so as to cause the user terminal to perform notification prompting execution of the action item. This enables a computer system to iteratively transform natural-language goal inputs into machine-tractable, numerically evaluated, and adaptively updated action plans using a generative AI model as a computational component, to optimize the timing and content of guidance and notifications, and thereby to improve the technical functioning of the computer in generating, managing, and refining user-specific behavioral schedules.

The term “goal information” refers to information representing an objective, target, or desired state that a user intends to achieve, expressed, for example, as natural-language text describing a time frame, quantity, or qualitative outcome.

The term “storage information” refers to information that has been written into and held by a storage device, including at least the goal information of a user and optionally additional related data such as timestamps, identifiers, and status indicators.

The term “storage device” refers to a hardware or virtual resource configured to store digital data, such as a memory device, a magnetic or optical storage medium, or a database system.

The term “prompt sentence” refers to text or a structured sequence of tokens that is provided as input to a generative AI model to specify instructions, conditions, context, or examples for generating an output.

The term “generative AI model” refers to a machine-learning model that generates output data, such as natural-language text or structured data, in response to input data including at least a prompt sentence.

The term “virtual entity” refers to a conceptual or digital representation of a person or agent, defined in terms of behavioral characteristics that simulate or exemplify actions leading to achievement of a user's goal.

The term “behavioral characteristics” refers to information describing patterns of actions, habits, routines, or decision rules associated with a virtual entity.

The term “behavioral information” refers to information output from the generative AI model that describes actions, routines, or behavior patterns of the virtual entity in natural-language or structured form.

The term “time information” refers to information that specifies temporal aspects of actions, including at least dates, times of day, durations, or periodicity.

The term “quantity information” refers to information that specifies numerical aspects of actions, including at least amounts, counts, intensities, or magnitudes, such as calories, minutes, repetitions, or distances.

The term “action-type information” refers to information that classifies or identifies the kind of action, such as exercise, study, dietary intake, rest, or other categories of user behavior.

The term “action plan information” refers to structured data representing one or more actions to be performed, each action being associated with at least time information, quantity information, and action-type information, and optionally with explanatory or contextual information.

The term “structured action plan information” refers to action plan information that is represented in a machine-readable format with explicit fields or attributes, enabling programmatic processing, numerical computation, and storage in a database.

The term “numerical computation” refers to processing that applies arithmetic or mathematical operations to numerical values contained in or derived from the action plan information.

The term “index” refers to a numerical indicator calculated by numerical computation, representing at least one of an amount of actions, a load amount, or a degree of achievement during a predetermined period.

The term “load amount” refers to a quantitative measure of burden or intensity associated with one or more actions, such as total exertion, cumulative time, or aggregated difficulty.

The term “degree of achievement” refers to a quantitative measure indicating how much a user's actual actions have satisfied conditions or targets defined in the goal information or action plan information.

The term “correction of the action plan information” refers to modification, adjustment, or refinement of the action plan information based on at least one of numerical computation results, constraints, or feedback, so as to update timing, quantities, or types of actions.

The term “user terminal” refers to an information processing apparatus operated by a user, such as a mobile device, a personal computer, or another client device capable of communicating with a server.

The term “schedule of actions” refers to a representation of action plan information organized according to temporal units, such as days or weeks, for presentation to a user.

The term “actual action information” refers to information indicating actions that the user has actually performed, including at least which planned actions were executed, modified, or omitted, and optionally including timestamps and measured quantities.

The term “update of the action plan information” refers to a process of revising, adding, or deleting elements of the action plan information based on actual action information or other inputs.

The term “attribute information of the user” refers to information describing characteristics of the user, such as age, preferences, capabilities, constraints, or other profile data relevant to planning or evaluating actions.

The term “notification time information” refers to information specifying one or more times at which a user terminal is to output a notification related to execution of an action item.

The term “notification message” refers to content presented to a user at a notification time, indicating at least an action item to be executed or related guidance.

The term “action item” refers to a unitary element of the action plan information, representing a specific action to be executed at a certain time or within a certain period with a certain quantity or intensity.

The term “notification” refers to output, by a user terminal, of information such as a message, alert, or reminder that prompts the user to perform an associated action item.

The term “explanatory information” refers to information that explains or contextualizes the behavioral characteristics of the virtual entity, and that is suitable for presentation to the user as guidance.

The term “concrete candidate action information” refers to information specifying particular actions that the user may choose to perform, derived at least in part from the behavioral characteristics of the virtual entity and presented as options for real actions.

In one embodiment, a server, a terminal, and a user cooperate to implement a system that converts user goal information into structured, adaptive action plans using a generative AI model driven by explicitly constructed prompt sentences. The server executes a program on hardware including at least one central processing unit (CPU), a main memory, a non-volatile storage device, and a network interface. The server further accesses a generative AI model executed on a computing apparatus equipped with an accelerator such as a graphics processing unit (GPU). The terminal comprises a computing device, such as a smartphone, a tablet, or a personal computer, including a display, an input interface, a CPU, a memory, and a communication interface. The user operates the terminal to provide input and to view guidance information.

The server uses a software configuration that may include an operating system, a web server component, an application framework, and a database management system. For example, the server uses a general-purpose operating system, a web server such as an HTTP server, and an application framework such as a server-side scripting framework or a web API framework. The server uses a relational database management system, such as a structured query language (SQL) database, to store goal information, action plan information, and log information. The server uses a communication library to send and receive messages over a network according to a protocol such as HTTPS.

The terminal executes client-side software such as a web browser or a native application. The terminal uses a graphical user interface toolkit to render input forms, lists, and schedules on the display. The terminal uses the communication interface to transmit user input to the server and to receive structured data from the server. The user uses a pointing device, a touchscreen, or a keyboard to input goal information and to provide feedback on executed actions.

The server acquires goal information from the user via the terminal. The server stores the goal information as storage information in a storage device in association with a user identifier and a timestamp. The server uses a data schema in which goal information is represented as records having fields such as goal text, time horizon, target quantity, and status. The server stores user attribute information and actual action information in related records, and the server links these records to the goal information using key fields.

The server constructs a prompt sentence to be input to a generative AI model. The server builds the prompt sentence using a data structure that separates a system instruction portion, a user-specific context portion, and a goal description portion. The server concatenates these portions in a predetermined order to form a single textual prompt sentence. For example, the server uses a prompt sentence such as:

“You are a virtual self who has already achieved the user's goal. Describe your typical daily and weekly behaviors in a concrete and realistic way, so that the user can follow them. The user's goal is: ‘I want to lose 5 kg in 3 months.’ Provide specific actions, such as meal patterns, exercise sessions, and sleep habits, including approximate times and quantities.”

In another example, the server uses a prompt sentence such as:

“You are a virtual self who has successfully become fluent in English conversation within one year. Describe your daily and weekly study routines in detail. The user's goal is: ‘I want to become fluent in English conversation within 1 year.’ Include specific activities such as listening practice, speaking practice, vocabulary learning, and review sessions, with approximate durations and frequencies.”

The server transmits the constructed prompt sentence to the generative AI model. In one embodiment, the generative AI model is a transformer-based neural network comprising multiple self-attention layers, feed-forward layers, and embedding layers. The generative AI model receives the prompt sentence as a sequence of tokens produced by a tokenizer. The model applies learned weight matrices to compute contextualized representations of the tokens and to generate output tokens sequentially according to a probability distribution. The generative AI model has been previously trained on training data using a loss function such as cross-entropy between predicted tokens and actual tokens. The training apparatus updates weight parameters by gradient-based optimization, such as stochastic gradient descent or an adaptive variant thereof, and may employ data augmentation methods such as random masking or shuffling of input segments.

The server receives behavioral information regarding the virtual entity generated by the generative AI model. The server stores the behavioral information as unstructured or semi-structured text in a storage device. The server then analyzes the behavioral information. The server uses a combination of rule-based parsing and pattern recognition to extract time information, quantity information, and action-type information. The server uses a library for text processing to identify patterns corresponding to dates, times, durations in minutes, counts of repetitions, numerical quantities (e.g., calories), and action categories (e.g., “run,” “walk,” “study English,” “prepare breakfast”). The server maps these extracted elements into a structured action plan information format, which may be represented as a set of records or objects having fields such as action identifier, date, start time, duration, action type, target quantity, and notes.

The server performs numerical computation over the structured action plan information. The server aggregates quantities per day, per week, and per goal period. The server calculates indices such as a total action amount, a load amount, and a degree of achievement. For example, the server computes the total minutes of exercise per week, the total study time per week, or the total calorie intake per day. The server uses formulas stored in configuration tables to map raw quantities to normalized indices. The server then corrects the action plan information based on these indices. The server adjusts daily or weekly loads to avoid excessive peaks and to smooth progression over time. The server may apply heuristic rules, such as capping daily exercise minutes, or more formal optimization methods, such as gradient-free search over discrete plan parameters, to distribute actions more evenly while preserving the total target load.

The server transmits the corrected action plan information to the terminal. The terminal receives the structured action plan and renders it as a schedule of actions on a daily basis or a weekly basis. The terminal organizes the data into calendar-like views or list views. The terminal displays action items with time labels, quantity labels, and action-type icons. The user views the presented schedule and uses the terminal to scroll between days and weeks. The user executes some actions in the physical world. The user then interacts with the terminal to input actual action information, such as completion of an exercise, partial completion of a study session, or skipping of a planned activity. The terminal transmits this actual action information to the server in structured form, including at least the action identifier, a completion status, and optionally a measured quantity and timestamp. The server updates the stored action plan information and calculates updated indices of degree of achievement and load. The server also updates models of user adherence, such as probabilities that the user will complete certain types of actions at certain times.

The server reconstructs the prompt sentence for the generative AI model based on the updated action plan information, the original goal information, and user attribute information. The server includes in the prompt sentence explicit references to which parts of the plan were completed or missed, and instructions to adapt the plan to better match observed behavior. For example, the server uses a prompt sentence such as:

“The user has the following goal: ‘I want to lose 5 kg in 3 months.’ The current virtual self plan includes 4 exercise sessions per week and 1800 kcal per day. The user has completed 70% of the planned exercise and 80% of the dietary targets in the first two weeks. Please adjust the plan for the next two weeks to improve adherence while maintaining reasonable progress, by slightly reducing daily exercise intensity and suggesting more flexible meal options.”

By incorporating explicit adherence data, the server forms a prompt sentence that directs the generative AI model to perform adaptation beyond what would be easily feasible using only static templates. The server sends the reconstructed prompt sentence to the generative AI model, obtains updated behavioral information of the virtual entity, and regenerates corresponding structured action plan information.

The server further generates notification time information from the structured action plan information. The server determines, for each action item, a notification time such as a predetermined offset prior to the planned start time. The server generates notification messages that refer to specific action items and their targets. The server transmits notification time information and corresponding notification messages to the terminal or to an external notification service. The terminal registers these notifications with an operating system-level scheduling mechanism. At the scheduled times, the terminal outputs notifications to the user, such as reminders or prompts to execute an action item.

In one embodiment, the generative AI model is implemented as a sequence-to-sequence neural network having a multi-layer transformer encoder-decoder architecture. The model uses input embeddings that incorporate token identity and positional encoding. The self-attention mechanism uses scaled dot-product attention across token positions, and the model uses layer normalization and residual connections to stabilize training. The training process uses mini-batches of text sequences and an optimizer that updates weights based on gradients computed with respect to the loss function. The server, or a training server, trains the generative AI model on a corpus that includes various examples of behavior descriptions and schedules, and then fine-tunes the model on a smaller dataset that emphasizes realistic, balanced plans and adherence-aware behaviors.

The server uses characteristic internal data structures to achieve technical improvements. For example, the server represents each action item as a tuple of (time slot identifier, action type code, quantity value, context flags). The server organizes these tuples in indexed tables for efficient retrieval by time range and action type. The server uses a specialized index on time slot identifiers so that queries for daily and weekly schedules are executed with reduced latency. The server also uses precomputed summary fields, such as daily totals and weekly totals, which the server updates incrementally when action items are added, removed, or corrected. This approach reduces the amount of computation required when the server recalculates indices for large planning horizons.

The server implements a rule-based post-processor that acts on the output of the generative AI model. Unlike simple human reading of natural-language advice, the server applies deterministic constraints and normalization rules to generated plans. For instance, the server enforces constraints such as maximum total planned exercise time per day, minimum sleep duration, and upper bounds on daily study hours. The server uses non-conventional combinations of constraints and objective functions to ensure that plans remain within safe and feasible ranges while still achieving the user's goal. This rule-based adjustment layer reduces variance and error in the model outputs and decreases the need for manual correction. The system improves computer technology in several ways. The server reduces communication load by transmitting compact structured action plan information rather than repeatedly transmitting long-form narrative text. The server improves computation efficiency by converting unstructured generative AI outputs into indexed data structures that can be processed using optimized database operations. The server enhances accuracy and stability of generated plans by combining statistical inferences from the generative AI model with deterministic numerical computations and constraints. The closed-loop architecture, in which user feedback is fed back into prompt construction and plan correction, enables the server to converge to action plans that are both realistic and computationally well-formed, thereby reducing error rates in scheduling and load estimation.

The server uses a modular architecture including at least a goal management module, a prompt construction module, a generative model interface module, an action plan structuring module, a numerical evaluation module, a notification scheduling module, and a user feedback integration module. Each module operates on well-defined data structures and interfaces. This modular design allows different generative AI models, data schemas, or optimization strategies to be substituted without altering the overall control flow. For example, one embodiment uses a large transformer-based generative AI model deployed on a remote inference service, while another embodiment uses a smaller locally hosted model running on the same physical server.

The terminal can adopt different interface embodiments. In one embodiment, the terminal uses a web-based interface that executes in a browser and renders schedules using web technologies. In another embodiment, the terminal uses a native application that accesses local sensors, such as motion sensors or heart-rate sensors, and sends additional actual action information to the server. In such an embodiment, the server uses sensor-derived measurements as additional inputs for numerical computation of load amounts and degrees of achievement.

The system is not limited to weight-loss or language-learning goals. The server can support goals in various domains, such as physical rehabilitation, professional skill development, or time management. The server adapts the prompt sentence and the interpretation of structured action plan information according to domain-specific rules. For example, for physical rehabilitation, the server places additional emphasis on safety constraints and medical guidelines; for professional skill development, the server generates task sequences that accumulate complexity over time.

By constructing explicit prompt sentences that encode goal information, user attributes, and action history, and by coupling these prompt sentences with structured plan generation, numerical evaluation, and feedback integration, the system uses the generative AI model as a core computational component rather than a simple text generator. The server thereby enables the computer to perform a series of operations that would be impracticable to execute manually with the same precision and speed, including large-scale parsing, aggregation, plan correction under constraints, and adaptive rescheduling. This leads to technical effects such as improved processing speed, reduced communication overhead, more accurate load estimation, and lower error in generated schedules, providing a concrete improvement to computer-based planning and guidance systems.

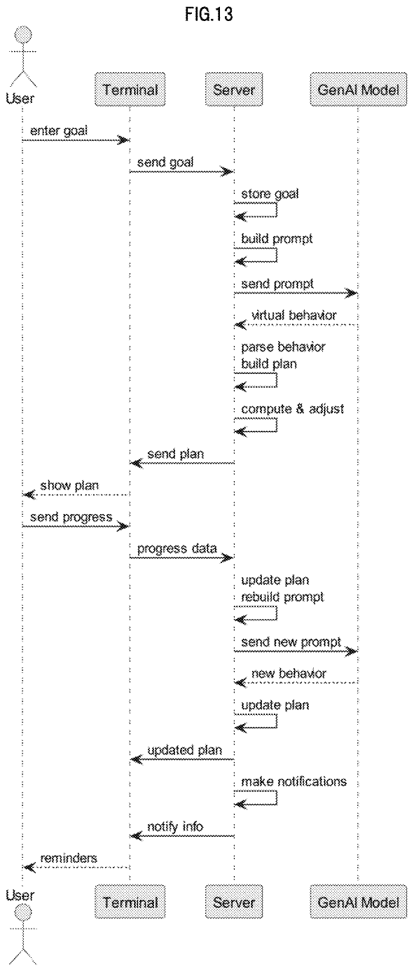

The following describes the processing flow using FIG. 13.

### Step 1

The user operates the terminal to launch an application and open a goal-input screen.

The terminal displays input fields for goal information (for example, a text box) and optional fields for time horizon and constraints.

The user inputs natural-language goal information, such as “I want to lose 5 kg in 3 months” or “I want to become fluent in English conversation within 1 year,” and then activates a send button.

The terminal generates a request object including at least the goal text, a user identifier, and a timestamp, and transmits this object to the server via a network.

The input of this step is user-entered goal information in natural-language form, and the output is a structured request containing the goal information transmitted from the terminal to the server.

### Step 2

The server receives the request from the terminal through a network interface and parses the request body.

The server validates the goal text (for example, checks that the text is not empty and that its length is within a threshold) and associates the goal information with the user identifier.

The server converts the goal text to a standard character encoding, trims extraneous whitespace, and optionally detects the language.

The server writes the normalized goal information and related metadata into a storage device as storage information, using a data schema including fields such as goal identifier, user identifier, goal text, and creation time.

The input of this step is the structured request from the terminal, and the output is a stored goal record in the storage device that is linked to the corresponding user.

### Step 3

The server reads, from the storage device, the goal information and any related user attribute information needed for planning.

The server constructs a prompt sentence for a generative AI model by combining a predefined system instruction, the user's goal information, and optional user attributes (for example, available time per day, fitness level, or language proficiency).

The server concatenates these text portions into a single, ordered prompt sentence, inserting markers or headings as necessary for clarity.

For example, the server generates a prompt sentence such as: “You are a virtual self who has already achieved the user's goal. Describe your typical daily and weekly behaviors in a concrete and realistic way. The user's goal is: ‘I want to lose 5 kg in 3 months.’ Include specific actions such as meal patterns, exercise sessions, and sleep habits, with approximate times and quantities.”

The server prepares the prompt sentence as input to the generative AI model, encapsulating it in a request message.

The input of this step is the stored goal information and user attribute information, and the output is a fully constructed prompt sentence ready to be sent to the generative AI model.

### Step 4

The server transmits the constructed prompt sentence to a generative AI model executed on an inference apparatus, via an API or another communication interface.

The server specifies model parameters such as a model name, a maximum number of output tokens, and a temperature value, and includes the prompt sentence as a text field in the request.

The generative AI model, which may be a transformer-based neural network, tokenizes the prompt sentence, performs internal matrix operations and attention operations to compute token probabilities, and generates output tokens corresponding to behavioral information of a virtual entity.

The server receives the generated text from the generative AI model and stores the raw behavioral information in the storage device, linked to the corresponding goal identifier.

The input of this step is the prompt sentence, and the output is unstructured or semi-structured behavioral information of the virtual entity, expressed as natural-language text.

### Step 5

The server reads the behavioral information of the virtual entity from the storage device and initiates an analysis process.

The server applies text-processing algorithms, including pattern matching, tokenization, and rule-based parsing, to identify time expressions (for example, “every morning at 7:00”), quantity expressions (for example, “30 minutes,” “1800 kcal,” “3 times per week”), and action expressions (for example, “run,” “study English,” “cook breakfast”).

The server converts detected expressions into normalized data, such as unified time units (minutes), numeric values for quantities, and standardized codes for action types.

The server constructs structured action plan information by creating records for each action item, with fields including at least date or time slot, action type code, quantity value, and descriptive notes.

The server stores the structured action plan information in the storage device for later processing.

The input of this step is unstructured behavioral information output from the generative AI model, and the output is structured action plan information containing machine-readable fields.

### Step 6

The server retrieves the structured action plan information and performs numerical computation on it.

The server aggregates quantities such as total exercise minutes per day, total study time per week, and total calorie intake per day by summing corresponding fields over specified time ranges.

The server calculates indices such as load amounts and degrees of achievement targets by applying formulas stored in configuration data, which may, for example, map total weekly exercise time to an intensity index.

The server detects excessive or insufficient loads by comparing computed indices against threshold values or recommended ranges.

The server corrects the action plan information by adjusting action quantities and timing; for example, the server reduces daily exercise time if the load index exceeds a maximum, or redistributes study sessions across more days when daily load is too high.

The server writes the corrected action plan information back into the storage device, replacing or versioning the previous plan.

The input of this step is the structured action plan information, and the output is corrected action plan information that has been numerically evaluated and adjusted.

### Step 7

The server extracts the corrected action plan information from the storage device and prepares data for presentation.

The server maps internal time slots to calendar dates and groups action items by day and week.

The server formats labels for display, such as human-readable dates, times, and descriptions derived from action-type codes and notes.

The server constructs a response message containing the corrected action plan information in structured form, including daily and weekly schedules.

The server transmits the response message to the terminal via the network.

The terminal receives the response, parses the structured data, and renders the schedule on the display, for example, as a calendar view or a list view with time-ordered action items.

The input of this step is the corrected action plan information, and the output is a human-readable schedule presented on the terminal's display.

### Step 8

The user inspects the schedule on the terminal and, in the physical environment, performs some of the suggested actions.

The user operates the terminal to indicate which action items were completed, partially completed, or not started, and optionally inputs measured quantities such as actual duration, distance, or calorie intake.

The terminal packages actual action information, including action identifiers, completion states, timestamps, and measured quantities, into a structured message and sends this message to the server.

The server receives the actual action information and updates corresponding records in the storage device, marking plan items with completion statuses and storing actual values.

The input of this step is the user's actual action information entered via the terminal, and the output is updated plan records in the storage device that reflect both planned and actual actions.

### Step 9

The server analyzes discrepancies between planned actions and actual actions by comparing planned quantities and times with actual values.

The server computes updated degrees of achievement and adherence indicators, such as completion rates for certain action types or time slots.

The server incorporates these updated indicators, along with the original goal information and user attribute information, to reconstruct a new prompt sentence.

The server explicitly describes, within the prompt sentence, which parts of the previous plan were followed and which parts were not, and instructs the generative AI model to propose adjusted behaviors to improve adherence while still targeting the user's goal.

For example, the server generates a prompt sentence such as: “The user completed about 60% of the planned evening exercise sessions but almost all of the morning walks. Adjust the next two weeks of the virtual self's plan to emphasize morning walks and reduce evening sessions while maintaining weight loss progress.”

The input of this step is actual action information and corrected action plan information, and the output is an updated prompt sentence that encodes feedback for the generative AI model.

### Step 10

The server sends the updated prompt sentence to the generative AI model and receives new behavioral information for the virtual entity, as in earlier steps.

The server repeats the analysis, structuring, numerical computation, and correction processes on the new behavioral information to generate a refined action plan that better matches the user's observed behavior.

The server writes the refined action plan into the storage device, overwriting or versioning older plans.

The server transmits updated schedule information to the terminal so that the user can view revised future actions.

The input of this step is the updated prompt sentence, and the output is a refined, updated action plan and corresponding schedule distributed to the terminal.

### Step 11

The server generates notification time information for each action item by referring to the action start times and applying predetermined offsets, such as sending a reminder 30 minutes before the planned start.

The server composes notification messages that refer to specific action items and include concise instructions or summaries, such as “Time for your 30-minute English listening practice” or “Reminder: 20-minute walk scheduled in 30 minutes.”

The server sends notification time information and notification messages to the terminal or to an external notification service.

The terminal registers local alarms or push notifications based on the received notification time information and messages.

At scheduled times, the terminal displays notifications to the user on the display or via other output mechanisms, prompting the user to execute corresponding action items.

The input of this step is the corrected or refined action plan information, and the output is scheduled notifications on the terminal that are tied to specific planned actions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computerized coaching and planning systems typically generate static action plans from user goals using fixed rule sets or single-shot inference. Such systems have several technical drawbacks. First, they do not maintain a structured, machine-interpretable representation of a “virtual entity” that simulates user behavior over time; instead, they output unstructured text that is difficult for downstream components to parse, adapt, and re-use. Second, the generation of guidance is not formulated as an iterative interaction between a prompt sentence and a generative AI model, and thus the system cannot efficiently refine an existing plan in response to changing contextual data while preserving internal consistency of the plan data structure.

Further, known systems generally treat user affective signals, such as images and audio that include facial expressions and voice tone, as mere ancillary information for user interfaces rather than as first-class inputs to core planning logic. As a result, conventional architectures do not integrate emotion state estimation tightly with the generation and update of machine-readable behavior plan data. Emotion-related information is typically processed separately from the plan generation pipeline, which leads to duplicated processing, increased latency, and difficulty in keeping the action guidance synchronized with the user's current emotional state.

In addition, prior approaches often send raw user inputs or loosely defined context strings directly to language models without a stable internal schema for prompts and responses. This causes variability in output formats, makes validation and storage of model outputs complex, and hinders reliable orchestration between a generative AI model, an emotion estimation model, and presentation components on terminal devices. The absence of a defined loop that (i) structures behavior plan data, (ii) records emotion state data, and (iii) programmatically constructs follow-up prompt sentences that incorporate these structured data, results in inefficient resource usage and limited ability to progressively personalize behavior plans. There is therefore a need for an improved computer-implemented system and server architecture that: (i) systematically converts user goal information into prompt sentences for a generative AI model; (ii) converts model outputs into normalized, time-series behavior plan data for a virtual entity; (iii) integrates an emotion estimation model that processes multimodal input from terminal devices into machine-readable emotion state data; and (iv) uses both the structured behavior plan data and the emotion state data to automatically construct additional prompt sentences and obtain updated, emotion-adaptive behavior plan data. Such a system should reduce processing redundancy, improve consistency of generated plans, and enhance the efficiency and reliability of the overall planning pipeline, thereby improving the functioning of the computer itself as a coordinated behavior-generation platform.

The specific processing by the specific processing unit 290 of the data processing device 12 in Application Example 2 is realized by the following means.

The present invention provides a server comprising a processor configured to acquire goal information of a user from a terminal device and construct a prompt sentence to be input to a generative AI model based on the goal information; to input the prompt sentence to the generative AI model and obtain behavior plan data of a virtual entity corresponding to the goal information; to structure, based on the behavior plan data, behaviors of the virtual entity as time-series behavior items stored with attribute information including at least a behavior type, an execution time, a duration, explanatory information, and an indication of whether the behavior item is emotion-adaptive; to generate visual content data that visually represents the behaviors of the virtual entity in association with the behavior plan data and store the visual content data in a storage device; to execute an emotion estimation model using image information and audio information acquired from the terminal device to estimate an emotional state of the user and record the estimated emotional state as emotion state data; to generate, based on the emotion state data and the behavior plan data, an additional prompt sentence for the generative AI model to update the behavior plan data of the virtual entity, input the additional prompt sentence to the generative AI model to obtain updated behavior plan data adapted to the emotional state, and add or modify the behavior items based on the updated behavior plan data; and to transmit, via a communication network to the terminal device, presentation information including behavior items based on the updated behavior plan data and the visual content data so that the user can view the behaviors of the virtual entity and adjust real-world behaviors with reference to the behaviors of the virtual entity. This enables the computer system to implement a closed computational loop that (i) maintains behavior plan data and emotion state data in structured, machine-readable form, (ii) programmatically constructs prompt sentences for the generative AI model using these structured data, and (iii) updates and presents emotion-adaptive behavior plans with reduced processing redundancy, improved internal consistency, and enhanced overall efficiency and reliability of behavior generation and presentation.

The term “processor” refers to a hardware computation unit or a combination of hardware computation units configured to execute instructions of a computer program to perform the functions described in the present specification.

The term “terminal device” refers to an information processing apparatus operated by a user, including but not limited to a mobile device, a wearable device, or a general-purpose computing device, that communicates with the server via a communication network.

The term “goal information” refers to data representing an objective or desired state specified by the user, including textual descriptions, parameter settings, and constraint information used as a basis for generating a behavior plan.

The term “prompt sentence” refers to a structured text string or data structure that is constructed for input to a generative AI model and that specifies conditions, instructions, or context for generating an output related to a behavior plan.

The term “generative AI model” refers to a machine learning model capable of generating output data, such as behavior descriptions or plans, in response to an input prompt sentence, using a learned statistical representation of patterns in training data.

The term “behavior plan data” refers to structured data representing actions of a virtual entity over time, including information about what actions are to be performed, when they are to be performed, and how they are to be executed.

The term “virtual entity” refers to a computational representation of an agent that simulates behaviors corresponding to the user's goal, and that serves as a reference model for the user's real-world actions.

The term “behavior item” refers to a unit element of the behavior plan data, representing a single action or activity of the virtual entity, associated with one or more attributes such as type, timing, and duration.

The term “attribute information” refers to data associated with a behavior item, including at least a behavior type, an execution time, a duration, explanatory information, and an indicator of emotion adaptation.

The term “behavior type” refers to a classification label that identifies a category of a behavior item, such as diet-related behavior, exercise-related behavior, rest-related behavior, or emotion-relief behavior.

The term “execution time” refers to temporal information indicating a scheduled time or time period at which a behavior item is to be performed by the virtual entity.

The term “duration” refers to temporal information indicating a length of time for which a behavior item is to be performed by the virtual entity.

The term “explanatory information” refers to descriptive data associated with a behavior item, including natural language text or structured annotations that explain the content or purpose of the behavior.

The term “indication of whether the behavior item is emotion-adaptive” refers to flag information or metadata that specifies whether a behavior item was generated or modified in response to an estimated emotional state of the user.

The term “visual content data” refers to data representing visual media, including but not limited to images, animations, or video sequences, that depict behaviors of the virtual entity based on the behavior plan data.

The term “storage device” refers to a hardware storage resource, such as a non-volatile memory device, a mass storage device, or a network-accessible storage system, used to store data including behavior plan data and visual content data.

The term “image information” refers to digital data representing still images or moving images of the user, such as facial images or body images, acquired by an imaging component of the terminal device.

The term “audio information” refers to digital data representing sound captured from the user, such as speech or non-speech sounds, acquired by an audio input component of the terminal device.

The term “emotion estimation model” refers to a trained computational model configured to input image information and audio information and output an estimated emotional state of the user.

The term “emotional state” refers to a state of the user's affect, such as stress, calmness, motivation, or fatigue, represented by discrete labels, continuous values, or a combination thereof.

The term “emotion state data” refers to structured data representing an estimated emotional state of the user, associated with at least one timestamp and optionally additional metadata.

The term “additional prompt sentence” refers to a prompt sentence generated after initial behavior plan data has been obtained, the additional prompt sentence being constructed using the behavior plan data, emotion state data, or both, to request an update of the behavior plan data from the generative AI model.

The term “updated behavior plan data” refers to behavior plan data that has been generated or modified in response to the additional prompt sentence, such that at least a part of the behavior items are adapted to the emotional state of the user.

The term “presentation information” refers to data prepared for output to the terminal device, including at least behavior items and associated visual content data, formatted for display or playback to the user.

The term “communication network” refers to any wired or wireless data communication infrastructure that enables data exchange between the server and the terminal device.

The term “history information regarding an execution status of behaviors” refers to recorded data representing whether, when, and how the user has executed, skipped, or modified suggested behavior items over time.

The term “context information” refers to data derived from analysis of history information, behavior plan data, emotion state data, or combinations thereof, which is added to a prompt sentence to condition or constrain output of the generative AI model.

The term “adherence tendency” refers to a characteristic pattern of the user's compliance with suggested behavior items, such as frequency, timing, or conditions under which the user executes or omits behaviors.

The term “free-form query text” refers to an input string in natural language provided by the user, which is not required to conform to a predetermined template and which expresses an additional request or question.

The term “behavior candidate data” refers to one or more candidate behaviors, expressed as structured data, generated by the generative AI model in response to a prompt sentence derived from the free-form query text.

The term “real-world behavior options” refers to actions that are recommended for the user to perform in the physical environment, presented as selectable options on the terminal device based on integrated behavior plan data.

In one embodiment, a server executes a computer program on a processor to implement the claimed system. The server is connected to at least one terminal device via a communication network. The server includes a central processing unit, a main memory, a non-volatile storage device, and a network interface. The server stores, in the non-volatile storage device, a server-side application, a generative AI model, an emotion estimation model, and one or more databases that hold behavior plan data, emotion state data, and visual content data. The server executes the application in the main memory to perform the functions described in the claims.

The terminal includes computation hardware, a display unit, at least one input device, a camera, and a microphone. The terminal executes a client application that transmits goal information, image information, audio information, and user feedback to the server, and that receives and displays behavior plan data and visual content data transmitted from the server. The server manages data using structured data models. The server defines a behavior plan table in a relational database, where each record corresponds to a behavior item and contains fields such as user identifier, virtual entity identifier, date, execution time, duration, behavior type, explanatory text, emotion adaptive flag, and linkage to associated visual content identifiers. The server defines an emotion state table, where each record contains user identifier, timestamp, emotion label, confidence score, and continuous parameters such as valence and arousal. The server defines a prompt log table, where each record includes a prompt identifier, prompt sentence text, model configuration parameters, and identifiers of the resulting behavior plan records.

The server constructs a generative AI model as a parameterized neural network trained offline before deployment. In one example, the server uses a transformer-based sequence model that receives a prompt sentence as a token sequence and outputs a token sequence representing a structured behavior plan. The server represents the prompt sentence using a subword encoding scheme, such as byte-pair encoding, and maps tokens to embedding vectors. The server stacks multiple self-attention layers and feedforward layers. The server trains the model using supervised learning on a corpus of historical goal descriptions and expert-designed behavior plans, minimizing a cross-entropy loss between predicted and reference token sequences. The server updates model weights using a gradient-based optimization method such as Adam and may employ regularization techniques such as dropout and label smoothing. The server may additionally fine-tune the model with reinforcement learning techniques to improve adherence-related performance criteria, such as predicted completion probability of suggested behaviors.

The server constructs the emotion estimation model as a multimodal neural network. The server implements a convolutional network to process image information, extracting facial features such as facial landmarks and expression patterns. The server implements a time-domain or frequency-domain network to process audio information, extracting features such as pitch, energy, and spectral characteristics. The server combines the visual and audio feature vectors in a fusion layer and passes them through fully connected layers to output discrete emotion labels and continuous affect values. The server trains the emotion estimation model with labeled image-audio pairs using a loss function combining categorical cross-entropy for labels and mean squared error for continuous affect values, and optimizes the weights with a gradient-based method. The server may perform data augmentation by applying random cropping, rotation, and illumination variance to image data and by applying time-stretching, additive noise, and pitch shifting to audio data, thereby improving robustness of the emotion estimation model.

The server constructs a behavior-generation pipeline that uses explicit data structures and control logic instead of a single opaque call to an AI model. The server first converts goal information from the terminal into a normalized internal representation with fields such as target metric, target value, target period, and constraints. The server then maps this internal representation to a prompt template to generate a prompt sentence for the generative AI model. The server uses templates that specify output format requirements and behavioral constraints to ensure that the generative AI model produces consistent and parsable outputs.

For example, the server generates a prompt sentence such as:

“The user's goal is to lose 5 kg in three months. Generate a detailed day-by-day behavior plan for a virtual self, including specific meal examples, exercise routines, and weekly check-ins, in a structured format (day, time, action, duration, notes).”

In another example, after emotion state information is obtained, the server generates an additional prompt sentence such as:

“The existing plan for today is: [summary of today's planned actions]. The user is currently stressed. Adjust the plan by adding short stress-relief actions such as deep breathing, light stretching, or a short walk, while keeping total daily workload reasonable. Output the updated plan in the same structured format.”

In a further example, the server generates a prompt sentence for a healthy lifestyle scenario such as: “The user's goal is to maintain a healthy diet. Simulate the virtual self's behavior in a virtual store and list the products that the virtual self chooses, with reasons.”

And in another case, the server generates a prompt sentence such as:

“The user's goal is to live a healthy life. Generate a virtual person optimized for this goal and output that person's typical weekly routine in a structured timeline.”

The server transmits the prompt sentence and associated configuration parameters to the generative AI model via an internal communication interface or an external model API. The server specifies parameters such as maximum output length, sampling temperature, and stop conditions. The server receives the model output as a text string or a structured string and applies a deterministic parsing procedure to map the output into behavior items. The server rejects malformed outputs that do not satisfy predefined schema constraints and, if needed, regenerates the prompt sentence to request re-formatting, thereby improving reliability of the behavior plan generation.

The server executes the emotion estimation model using image information and audio information provided by the terminal. The server preprocesses images by converting them to a fixed resolution, normalizing pixel values, and detecting faces. The server preprocesses audio by converting signals into mel-spectrograms. The server feeds these preprocessed features to the neural network to obtain emotion state data. The server stores emotion labels and continuous affective parameters with timestamps, so later logic can correlate emotion states with particular behavior items and time ranges.

The server implements a control module that combines behavior plan data and emotion state data to construct additional prompt sentences for the generative AI model. The server analyzes recent emotion records for each user and identifies patterns such as repetitive stress during certain time ranges or low motivation before specific types of tasks. The server also records execution status of behavior items submitted by the terminal, calculating adherence statistics such as completion rate, average delay, and re-scheduling frequency. The server uses this analysis to generate context information that is appended to subsequent prompt sentences. For example, the server may construct a prompt sentence:

“The user often skips high-intensity workouts after 9 pm. When generating or adjusting the plan, schedule lighter tasks after 9 pm and move high-intensity tasks to earlier time slots.”

By embedding such context information, the server causes the generative AI model to generate updated behavior plan data that is personalized not only to the goal but also to past adherence patterns and emotion trends.

The server generates visual content data that corresponds to the behavior plan data. In one embodiment, the server uses a rendering engine to map behavior types to visual templates, such as an avatar performing exercise, eating particular foods, or engaging in relaxation activities. The server uses an intermediate scene description format in which each behavior item is converted into a scene node with parameters such as animation identifier, start time within a timeline, duration, camera position, and overlay text. The server converts this scene description into a video file using a graphics engine and a media encoder. The server may use an external video processing tool to compress and segment the generated video for adaptive streaming. The server maintains an index mapping behavior plan identifiers to content file locations, allowing the terminal to request and cache relevant video segments efficiently.

The server uses these data structures and algorithms to achieve several technical effects. Because the server structures the model output into behavior items with explicit attributes, the server can perform incremental updates rather than regenerating entire plans for minor changes. This reduces computation cost and network bandwidth usage. Because the server uses emotion state data and adherence history as structured inputs to prompt sentences, the server reduces the number of iterations required to obtain stable, user-appropriate behavior plans, improving processing speed and consistency. Because the server uses schema-constrained parsing and validation of model outputs, the server reduces error rates in integrating AI-generated content into the system database, thereby improving reliability of the computer system as a whole. The server's ability to maintain normalized behavior plan data also improves data management and enables efficient indexing and retrieval of relevant actions for display on the terminal.

The server uses control logic that is not a mere automation of human planning. The server enforces non-intuitive rules such as limiting the total number of high-intensity tasks per day based on calculated load indices, automatically inserting rest periods into the plan when cumulative duration exceeds thresholds, and adjusting timing of tasks according to circadian patterns inferred from past data. These rules combine with the generative AI model in a hybrid architecture. The server uses the generative AI model primarily for generating creative and semantically plausible action content, while the server uses deterministic algorithms to enforce constraints and maintain consistent data structures. This hybrid approach yields plans that would be difficult to create manually at scale, while simultaneously improving computational properties such as predictability of runtime and bounded resource consumption.

The server, by repeatedly constructing prompt sentences from structured data and feeding updated outputs back into the same structured representation, implements a closed loop that improves computer functionality. In conventional systems that directly display unstructured model outputs to users, additional applications must perform ad hoc parsing, and stateful adaptation is difficult. In contrast, the present server maintains internal consistency through explicit schema and by storing all data in a normalized database. This allows the server to parallelize execution of emotion estimation, behavior generation, and content rendering, and to cache intermediate results. Thus, the server can respond more quickly to user updates and can reduce redundant recomputation, providing tangible improvements in processing speed and computational efficiency.

The terminal interacts with the server to realize the claimed system. The terminal acquires goal information and transmits it to the server using a secure communication protocol. The terminal receives behavior plan data and visual content data and maps them onto display components such as calendars, time-line views, and video players. The terminal uses local storage to cache frequently used content and behavior fragments so that repeated viewing does not require re-downloading the same data. This reduces network traffic and improves responsiveness. The terminal uses the camera and microphone to acquire image information and audio information at intervals or in response to user actions. The terminal may perform basic compression or downsampling before sending media data to the server, thereby reducing communication load while preserving sufficient resolution for the emotion estimation model to operate reliably.

The user interacts with the terminal to provide goals and feedback. The user may enter a goal such as “I want to lose 5 kg in three months” or “I want to live a healthy life” into a text input field and may check constraints such as preferred exercise frequency or dietary restrictions. The user observes the behaviors of the virtual entity through the terminal's display and adjusts real-world behaviors in reference to the suggested actions. The user may provide feedback by marking tasks as completed, skipped, or postponed. The user may also input free-form queries such as “Add coping strategies for exam anxiety” or “Create a weekly exercise plan based on my current schedule.” The terminal forwards these queries to the server, which converts them into structured prompt sentences with context extracted from existing behavior plan data and emotion state data.

In another embodiment, the server may use an alternative neural network architecture for the generative AI model, such as a recurrent neural network with attention, or a hybrid model that combines a sequence-to-sequence structure with a graph component that explicitly represents dependencies between behaviors. The server may also use a different emotion estimation architecture that focuses on temporal modeling of emotion changes, using recurrent units or temporal convolution to capture time-varying patterns in facial expressions and speech.

In a further embodiment, the server may implement the databases using a document-oriented datastore instead of a relational database. The server then stores behavior items as document objects with nested fields and uses an index to quickly retrieve items for a given user and date range. The server may also offload visual content generation to a specialized content generation service, while preserving the same interface: the server transmits a normalized scene description, and the content generation service returns a content identifier. In yet another embodiment, the server may adjust the frequency of emotion sampling and plan updating based on network conditions and computational load. The server may dynamically choose lower-resolution features or smaller models during high load periods to maintain real-time responsiveness. The server may also compress behavior updates and send only differences between previous and new plans to the terminal. This delta transmission further reduces communication overhead and contributes to improved performance of the system.

Through these embodiments, the server, the terminal, and the user cooperate to realize a system that goes beyond abstract data processing. The system dynamically generates, structures, adapts, and presents behavior guidance for a virtual entity using a generative AI model and an emotion estimation model as components within a carefully defined computational architecture. The specific design of data structures, prompt construction, model training, and pipeline orchestration provides concrete improvements in speed, robustness, and manageability of computer-implemented planning and presentation, thereby satisfying technical requirements for implementation and supporting the scope of the claims.

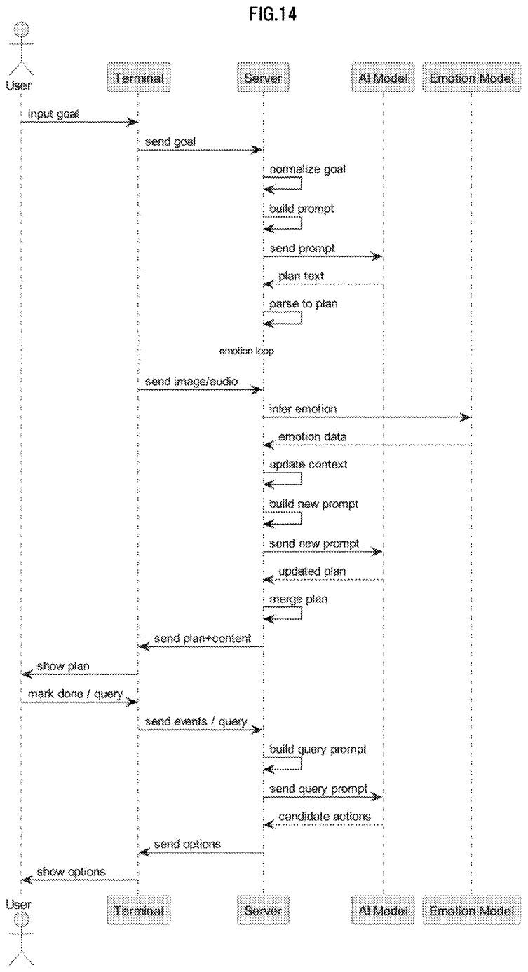

The following describes the processing flow using FIG. 14.

### Step 1

User operates the terminal to input goal information.

User enters a goal in natural language (for example, “I want to lose 5 kg in three months” or “I want to live a healthy life”) and, optionally, additional constraints (for example, “no gym,” “vegetarian,” “20 minutes per day”) via text fields, selection widgets, or sliders on the terminal.

Input: raw user inputs (goal text, constraint selections, user identifier, timestamp).

Output: structured goal information packaged on the terminal (for example, JSON with fields goal_text, constraints, user_id, created_at) ready for transmission.

### Step 2

Terminal transmits the goal information to the server.

Terminal calls a predefined network API endpoint (for example, HTTPS POST to/api/goals) using a communication library and embeds the structured goal information into the request body. Terminal sets headers such as content type and authentication token and waits for a response from the server.

Input: structured goal information generated in Step 1.

Output: network request to the server carrying the goal information; acknowledgement from the server (for example, a request identifier) stored by the terminal.

### Step 3

Server receives and normalizes the goal information.

Server accepts the network request through a web application framework, parses the request body, and validates that required fields are present. Server normalizes the goal text by trimming whitespace, standardizing number formats and dates, and mapping constraint selections to internal codes. Server stores the normalized goal record in a goal table in a database.

Input: structured goal information from the terminal.

Output: normalized goal record (for example, fields: user_id, target_metric, target_value, target_period, constraint_codes) stored in persistent storage.

### Step 4

Server constructs a prompt sentence for the generative AI model.

Server maps the normalized goal record to a prompt template and inserts data such as target value and period into designated placeholders. Server also appends system-level instructions specifying output format and constraints (for example, “output as a day-by-day plan with fields: date, time, action, duration, notes”). Server concatenates these parts into a complete prompt sentence string and registers the prompt with a prompt log in the database.

Input: normalized goal record from Step 3.

Output: prompt sentence string and associated prompt metadata (for example, temperature, max_tokens) ready to be sent to the generative AI model and recorded in a prompt log.

### Step 5

Server transmits the prompt sentence to the generative AI model and obtains raw model output.

Server sends the prompt sentence and model configuration parameters to the generative AI model via an internal model interface or a remote API. Server tokenizes the prompt sentence if the model is local, or delegates tokenization to the model service if remote. Server receives the model's output as a text sequence that is expected to encode a behavior plan for a virtual entity.

Input: prompt sentence and model configuration parameters.

Output: raw model output text representing a candidate behavior plan.

### Step 6

Server parses the raw model output into structured behavior plan data.

Server applies a deterministic parser to the model output, splitting the text by lines or delimiters and mapping segments to fields such as date, time, action description, duration, and category. Server converts date and time strings into standardized timestamps and validates that mandatory fields are present for each behavior item. Server discards malformed entries and may request regeneration if too many errors occur. Server stores validated entries as behavior plan records in the behavior plan table.

Input: raw model output text from Step 5.

Output: structured behavior plan data composed of multiple behavior item records linked to the corresponding user and goal.

### Step 7

Server enriches each behavior item with attribute information.

Server classifies each behavior item into a behavior type (for example, diet, exercise, rest, stress-relief) using rule-based mapping or a lightweight classifier. Server computes derived attributes such as estimated calorie expenditure, total daily duration, and load index based on configuration tables and known formulas. Server adds explanatory information, such as short natural-language explanations or tags, and sets the emotion-adaptive flag to false at this stage. Server updates behavior item records with these attributes in the database.

Input: basic behavior item records from Step 6.

Output: enriched behavior plan data, where each behavior item has behavior type, execution time, duration, explanatory information, and emotion-adaptive flag fields populated.

### Step 8

Server generates visual content descriptors for behavior items.

Server maps each behavior type and action description to a visual template identifier and parameters (for example, avatar animation ID, environment ID, overlay text). Server aggregates these descriptors into a time-ordered scene description, with fields such as timeline position, animation start, animation duration, and associated behavior item identifier. Server stores the scene description as visual content metadata linked to the behavior plan data.

Input: enriched behavior plan data from Step 7.

Output: visual content descriptors (scene description data) associated with behavior items and stored in a content metadata table.

### Step 9

Server renders and stores visual content data (in embodiments with video or animation).

Server passes the scene description to a rendering engine, which generates individual frames or animation sequences for the virtual entity executing each behavior. Server encodes rendered frames into a video file or a set of media segments using a media encoder. Server stores the resulting media objects in a storage system and updates content metadata with file paths or content identifiers.

Input: visual content descriptors from Step 8.

Output: visual content data (video or animation files) and updated metadata linking files to specific behavior items and plans.

### Step 10

Terminal acquires image information and audio information for emotion estimation.

Terminal activates the camera and microphone in accordance with user permissions and captures facial images or short video clips as well as voice audio while the user is interacting with the system or at scheduled times. Terminal compresses these media samples and attaches metadata including timestamps and context labels (for example, before workout, after daily tasks). Terminal prepares a structured packet combining media data and metadata.

Input: raw sensor data from the camera and microphone.

Output: compressed image information and audio information packaged with metadata and ready for transmission to the server.

### Step 11

Terminal transmits emotion-related media to the server.

Terminal sends the structured packet containing image information, audio information, and metadata to a dedicated emotion API endpoint on the server over a secure communication channel. Terminal may batch multiple samples to reduce overhead or send them in near real time, depending on configuration and network state.

Input: packaged image and audio data from Step 10.

Output: network request to the server containing emotion-related media data.

### Step 12

Server preprocesses image and audio information for emotion estimation.

Server decodes received image data into a fixed-size pixel array and runs a face detection routine to locate the user's face. Server crops and normalizes face regions. Server decodes audio data into a waveform, computes features such as mel-spectrograms or MFCCs, and normalizes values. Server packages visual and audio feature arrays as inputs to the emotion estimation model.

Input: compressed image information and audio information from the terminal.

Output: preprocessed feature tensors representing facial and audio characteristics of the user.

### Step 13

Server executes the emotion estimation model and records emotion state data.

Server inputs the preprocessed visual and audio feature tensors into the multimodal emotion estimation neural network. Server obtains predicted emotion labels and continuous affect values (for example, valence, arousal) along with confidence scores. Server creates an emotion state record combining the predictions with the corresponding user identifier and timestamp. Server writes this emotion state record to the emotion state table in the database.

Input: feature tensors from Step 12.

Output: emotion state data records containing estimated emotional states and associated metadata.

### Step 14

Server correlates emotion state data with corresponding behavior items.

Server retrieves recent emotion state records for a user and identifies which behavior items were scheduled or executed around the same timestamps, using time windows and user identifiers. Server flags behavior items that coincide with specific emotion states (for example, stress before exercise) and stores these associations in a linkage table. Server computes aggregate statistics such as average emotion levels before and after certain behavior types.

Input: emotion state data from Step 13 and behavior plan data from previous steps.

Output: correlation information and aggregated statistics linking behavior items to emotion states.

### Step 15

Server analyzes adherence history and computes adherence metrics.

Server retrieves execution status events sent by the terminal (for example, completed, skipped, postponed) for behavior items, and combines them with scheduled data. Server calculates metrics such as per-type completion rate, average delay between scheduled and actual execution, and patterns of skipping. Server stores these metrics in an adherence statistics table and may update per-user, per-behavior type profiles.

Input: behavior plan data and execution event logs from the terminal.

Output: adherence metrics and statistical profiles describing user execution tendencies.

### Step 16

Server generates context information for use in subsequent prompt sentences.

Server combines correlation information between emotion and behaviors with adherence metrics to derive context, such as “user often feels stressed before late-night high-intensity workouts and skips them.” Server encodes this context as structured text snippets or key-value pairs and associates them with the user and current goal.

Input: correlation information from Step 14 and adherence metrics from Step 15.

Output: context information records that summarize patterns of emotion and adherence.

### Step 17

Server constructs an additional prompt sentence for updating the behavior plan.

Server retrieves the current behavior plan segment (for example, today or this week), emotion state summaries, and context information. Server inserts these elements into a prompt template that instructs the generative AI model to adjust the plan. Server, for example, generates a prompt sentence such as: “The existing plan for today is: [summary]. The user is currently stressed and often skips high-intensity workouts after 9 pm. Adjust the plan by inserting short stress-relief actions and moving high-intensity tasks to earlier times.”

Input: current behavior plan data, emotion state data, and context information.

Output: additional prompt sentence and associated metadata prepared for submission to the generative AI model.

### Step 18

Server requests updated behavior plan data from the generative AI model.

Server transmits the additional prompt sentence, along with necessary configuration parameters, to the generative AI model. Server receives updated plan recommendations encoded in text. Server parses these recommendations using the same schema-based parser as in earlier steps to create updated behavior item records. Server compares updated records with existing ones to determine which items are new, modified, or removed.

Input: additional prompt sentence from Step 17.

Output: updated behavior plan data reflecting emotion-adaptive and adherence-aware adjustments.

### Step 19

Server merges updated behavior items into the stored behavior plan.

Server applies a merge policy that replaces or augments existing behavior items with updated versions. Server marks updated or newly added items with an emotion-adaptive flag and logs changes in a plan history table. Server ensures that overall schedule constraints, such as maximum daily workload, remain satisfied, optionally adjusting timing or duration to enforce constraints.

Input: existing behavior plan data and updated behavior plan data from Step 18.

Output: consolidated behavior plan data containing emotion-adaptive and constraint-consistent behavior items.

### Step 20

Server prepares presentation information for the terminal.

Server assembles a response object that includes the consolidated behavior plan data for a specific time range, references or URLs for corresponding visual content data, and annotations indicating which items are emotion adaptive or newly changed. Server formats the data into a structured payload suitable for transfer (for example, JSON).

Input: consolidated behavior plan data and visual content metadata.

Output: presentation information payload ready to be sent to the terminal.

### Step 21

Server transmits the presentation information to the terminal.

Server sends the presentation payload to the terminal via a response to an explicit request or via a push notification channel. Server may also provide differential updates that only include items newly added or modified, to reduce bandwidth.

Input: presentation information from Step 20.

Output: network response containing updated plan and content information delivered to the terminal.

### Step 22

Terminal updates its local state and displays the behavior plan and visual content.

Terminal parses the received presentation information and updates its local storage of behavior items, replacing or augmenting existing entries. Terminal schedules downloads of any referenced visual content files not already cached. Terminal renders an updated user interface showing daily or weekly plans, highlighting emotion-adaptive items, and enabling the user to play visual content displaying the virtual entity's behaviors.

Input: presentation information from the server.

Output: updated on-device behavior schedule, cached content files, and rendered UI components visible to the user.

### Step 23

User reviews the updated plan and adjusts real-world actions.

User examines the suggested behaviors and watches the corresponding visual representation of the virtual entity. User decides which real-world actions to perform and executes them accordingly (for example, following a specific workout or stress-relief routine). User marks completion or modification of tasks through the terminal interface.

Input: displayed behavior items and visual content.

Output: user-generated execution events (completed, skipped, postponed) and optionally free-form feedback or additional queries.

### Step 24

Terminal records execution events and additional user queries and transmits them to the server.

Terminal logs user interactions, including task status changes and any new query text (for example, “Add coping strategies for exam anxiety” or “Create a weekly exercise plan based on my current schedule”). Terminal bundles these events into an update packet and sends them via the network API to the server.

Input: execution events and query text produced by the user in Step 23.

Output: structured event and query data transmitted to the server.

### Step 25

Server converts free-form queries into supplemental prompt sentences.

Server analyzes incoming query text in combination with current goal, behavior plan data, and context information. Server maps the query to a template that frames the query as a modification or extension of the existing plan. Server constructs a supplemental prompt sentence that instructs the generative AI model to output additional or modified behavior items that are compatible with the current plan structure.

Input: user query text, current behavior plan data, and context information.

Output: supplemental prompt sentence targeted to the generative AI model for generating new behavior candidate data.

### Step 26

Server obtains behavior candidate data and integrates it into the plan.

Server sends the supplemental prompt sentence to the generative AI model and receives behavior candidate descriptions. Server parses these descriptions into structured behavior items, validates them, and determines how they can be inserted into the existing plan (for example, adding new tasks, replacing less effective tasks). Server updates the behavior plan data and flags these items as candidate-driven modifications, then prepares them for presentation to the user as selectable options.

Input: supplemental prompt sentence from Step 25.

Output: integrated behavior plan data that include behavior candidate items ready to be displayed as real-world behavior options on the terminal.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

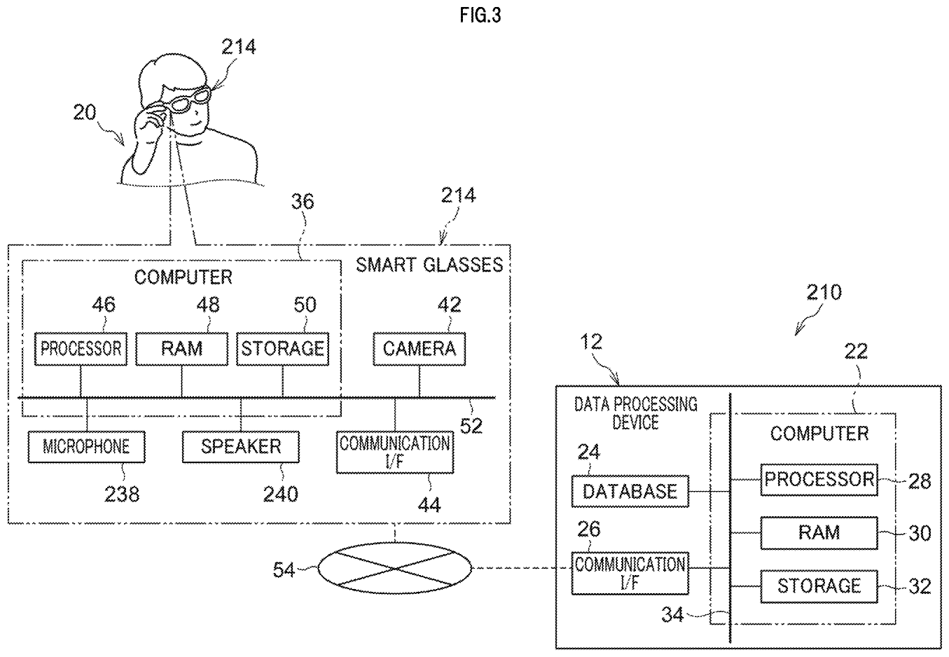

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

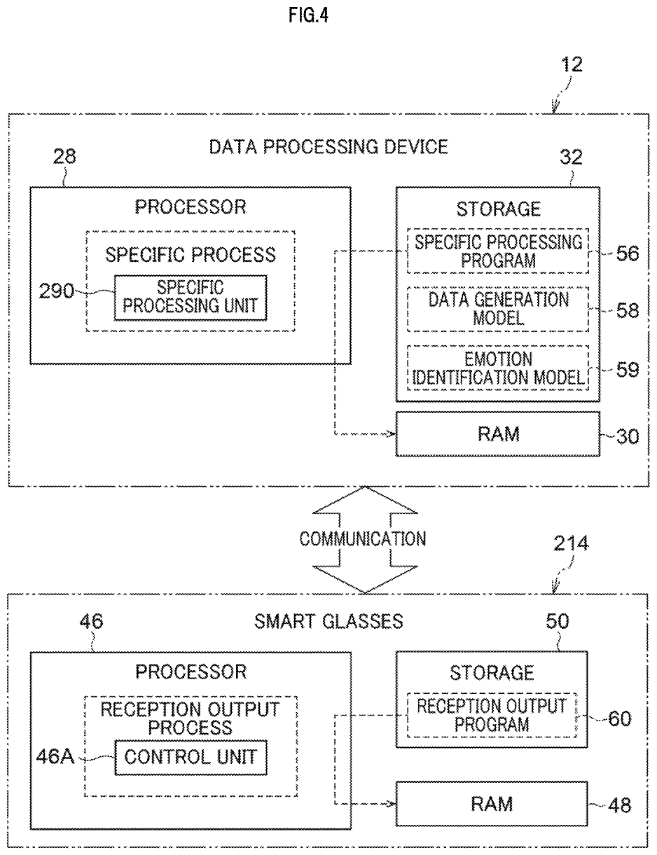

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

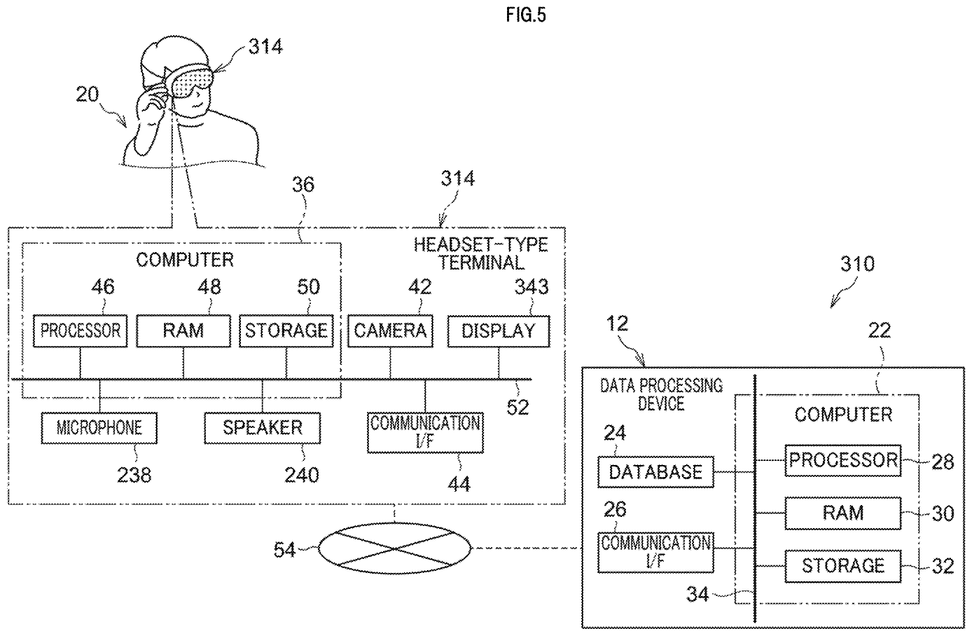

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

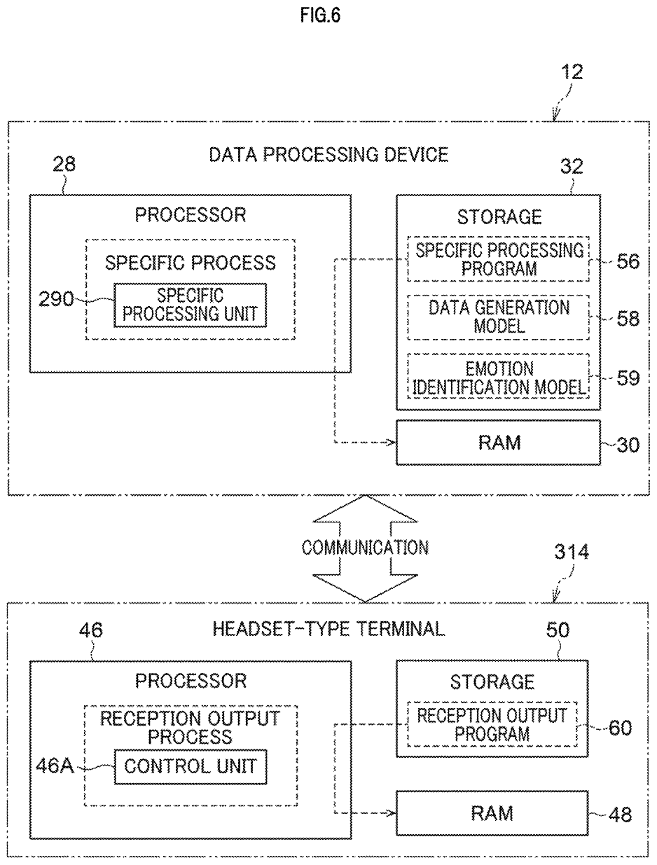

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

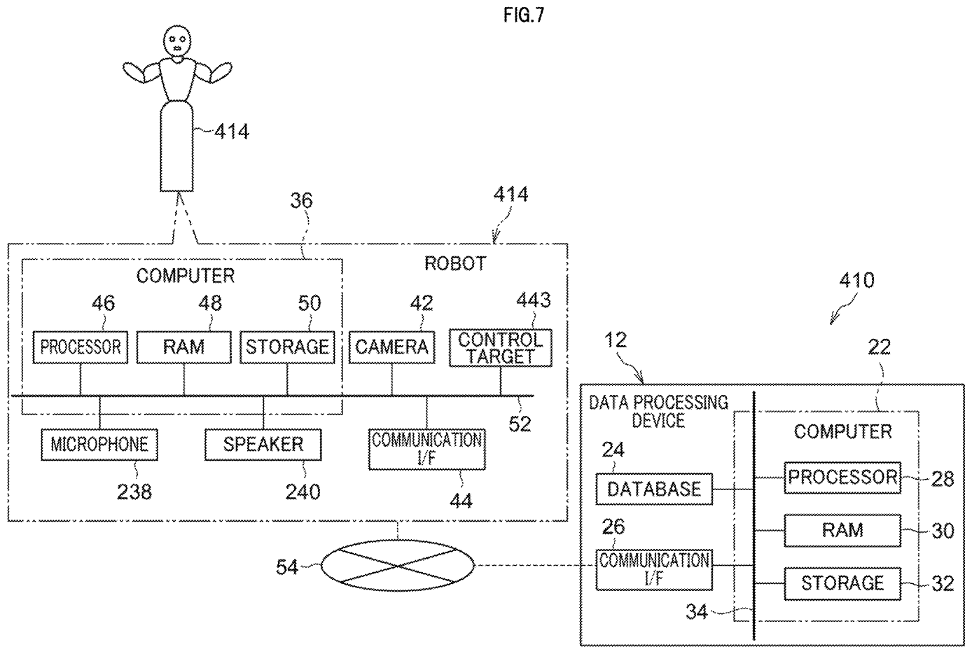

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

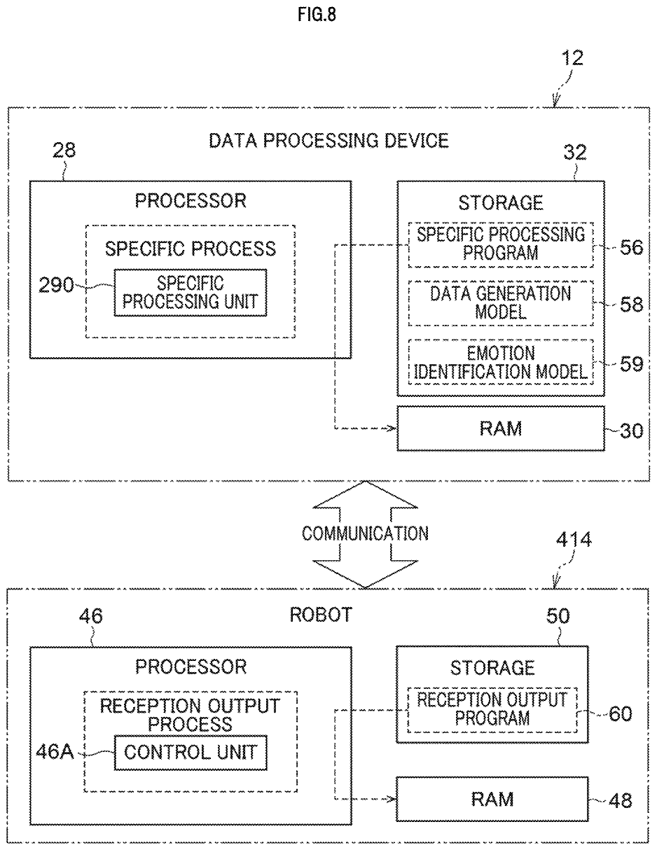

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

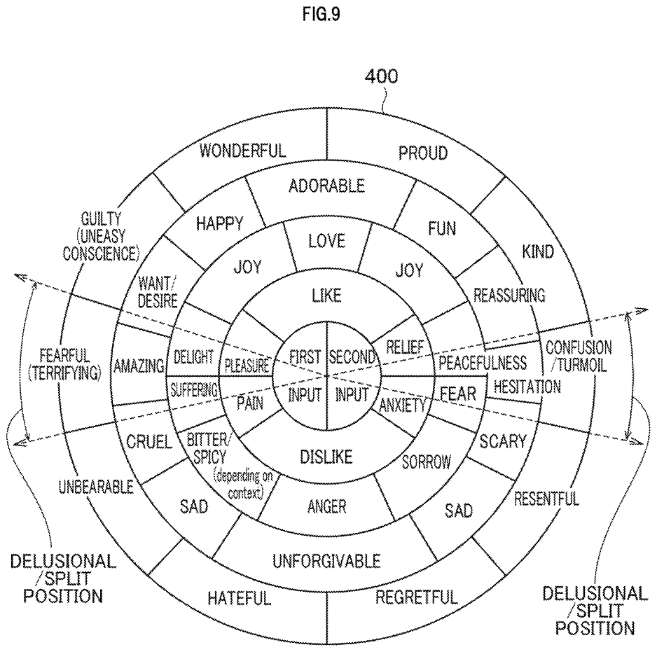

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

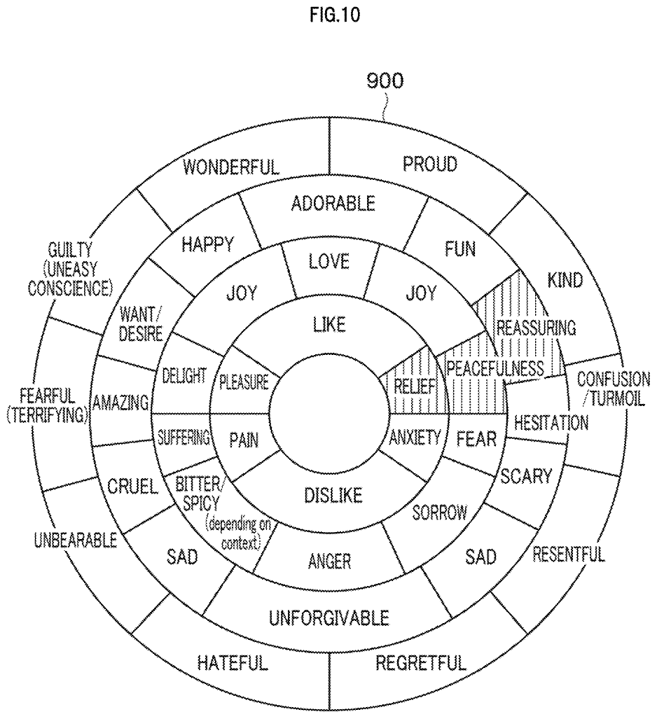

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### Supplementary 1

A system comprising a processor,

wherein the processor is configured to

receive goal information of a user from a user terminal and store the goal information as stored information in a storage unit,

generate, in accordance with the goal information, a prompt sentence that instructs a generative artificial intelligence model to generate goal-achievement behavior of a virtual person, input the prompt sentence into the generative artificial intelligence model, and obtain generated text information indicating an action plan of the virtual person from the generative artificial intelligence model,

analyze the generated text information to convert the generated text information into structured action-plan information including a plurality of action elements each having at least time information, period information, category information, and description information, and format the structured action-plan information into presentation data that is transmittable to the user terminal,

transmit the presentation data to the user terminal so that the user terminal presents, to the user, a task list or a schedule based on behavior of the virtual person, and

calculate an achievement degree of the structured action-plan information on the basis of behavior-execution status information received from the user terminal, generate an update prompt sentence reflecting the achievement degree, input the update prompt sentence into the generative artificial intelligence model, and update the action plan on the basis of updated generated text information.

### Supplementary 2

The system according to supplementary 1,

wherein the processor is configured to

generate the prompt sentence so as to include an instruction that causes the generative artificial intelligence model to execute a behavior simulation in which the virtual person achieves the goal information within a period corresponding to the goal information, and

specify an output format of the generated text information such that the structured action-plan information obtained by the analysis is stored as action elements on a per-day basis or on a per-week basis.

### Supplementary 3

The system according to supplementary 1,

wherein the processor is configured to

cause the presentation data to include, as behavior candidates for real behavior of the user, a plurality of selectable options based on the behavior of the virtual person, and to add or modify the behavior candidates on the basis of the generated text information obtained from the generative artificial intelligence model and the update prompt sentence.

### Application Example 1

### Supplementary 1

A system comprising a processor, a storage device, a communication interface, and a generative AI model interface,

wherein the processor is configured to

receive, via the communication interface, goal information of a user from a user terminal over a communication network, and store the goal information in the storage device,

generate a prompt sentence based on the goal information so as to cause a generative AI model to generate behavior information of a virtual person who attempts to achieve a goal corresponding to the goal information, provide the prompt sentence to the generative AI model through the generative AI model interface, and obtain, from the generative AI model, output information including the behavior information of the virtual person,

analyze the output information to extract one or more behavior keywords representing behaviors of the virtual person,

search, in the storage device, a data set including item information or service information based on the one or more behavior keywords, and select one or more candidate items or one or more candidate services associated with the behaviors of the virtual person,

generate recommendation information in which the behaviors of the virtual person and the one or more candidate items or the one or more candidate services are associated with each other, and transmit the recommendation information to the user terminal via the communication interface so that the recommendation information is presented to the user, receive, from the user terminal via the communication interface, selection information indicating one or more behaviors or one or more candidate items or one or more candidate services selected by the user based on the recommendation information, and generate a prompt sentence for an action plan based on the selection information, provide the prompt sentence for the action plan to the generative AI model through the generative AI model interface, and obtain, from the generative AI model, output information including the action plan for achieving the goal of the user, and

transmit the output information including the action plan to the user terminal via the communication interface so that the action plan is presented to the user.

### Supplementary 2

The system according to supplementary 1,

wherein the processor is configured to embed the goal information of the user into a template to generate the prompt sentence, and to instruct, by the prompt sentence, the generative AI model to output, as the output information, both specific daily and weekly behaviors of the virtual person and item information or service information supporting the behaviors, in a form in which the behaviors and the item information or the service information are distinguished from each other.

### Supplementary 3

The system according to supplementary 1,

wherein the processor is configured to analyze the output information including the behavior information of the virtual person as structured data including heading information and list information, and, based on the structured data, to generate user interface information that causes the user terminal to display a presentation region for the behaviors of the virtual person and to present the one or more candidate items or the one or more candidate services as selectable options.

### EXAMPLE 2

### Supplementary 1

A system comprising a processor,

wherein the processor is configured to

acquire goal information of a user and store the goal information as storage information in a storage device,

construct, on the basis of the goal information and the storage information, a prompt sentence for causing a generative AI model to generate behavioral characteristics of a virtual entity, and input the prompt sentence to the generative AI model,

analyze behavioral information regarding the virtual entity output from the generative AI model, extract time information, quantity information, and action-type information from the behavioral information, and generate structured action plan information,

perform numerical computation on the basis of the action plan information to calculate an index regarding an amount of actions, a load amount, or a degree of achievement in a predetermined period, and correct the action plan information on the basis of a result of the numerical computation,

transmit the corrected action plan information to a user terminal and cause the user terminal to present the corrected action plan information as a schedule of actions on a daily basis or a weekly basis,

acquire actual action information of the user via the user terminal and update the action plan information on the basis of the actual action information, and

reconstruct, on the basis of the updated action plan information, the prompt sentence for the generative AI model and cause the generative AI model to regenerate the virtual entity and the action plan information.

### Supplementary 2

The system according to supplementary 1,

wherein the processor is configured to

generate notification time information for each action item on the basis of the structured action plan information, and transmit the notification time information and a notification message corresponding to each action item to the user terminal so as to cause the user terminal to perform notification prompting execution of the action item.

### Supplementary 3

The system according to supplementary 1,

wherein the processor is configured to

generate the prompt sentence by integrating a plurality of types of information including the goal information of the user, attribute information of the user, and the actual action information, and cause the generative AI model to output explanatory information for presenting the behavioral characteristics of the virtual entity as options for real actions of the user and concrete candidate action information.

### Application Example 2

### Supplementary 1

A system comprising a processor,

wherein the processor is configured to

acquire goal information of a user from a terminal device and construct a prompt sentence to be input to a generative AI model based on the goal information, input the prompt sentence to the generative AI model, and thereby obtain behavior plan data of a virtual entity corresponding to the goal information,

structure, based on the behavior plan data, behaviors of the virtual entity as time-series behavior items, and store each behavior item as attribute information including at least a behavior type, an execution time, a duration, explanatory information, and an indication of whether the behavior item is emotion-adaptive,

generate visual content data that visually represents the behaviors of the virtual entity in association with the behavior plan data, and store the visual content data in a storage device, execute an emotion estimation model using image information and audio information acquired from the terminal device to estimate an emotional state of the user, and record the estimated emotional state as emotion state data,

generate, based on the emotion state data and the behavior plan data, an additional prompt sentence for the generative AI model to update the behavior plan data of the virtual entity, input the additional prompt sentence to the generative AI model to obtain updated behavior plan data adapted to the emotional state, and add or modify the behavior items based on the updated behavior plan data, and

transmit, via a communication network to the terminal device, presentation information including behavior items based on the updated behavior plan data and the visual content data, so that the user can view the behaviors of the virtual entity and adjust real-world behaviors with reference to the behaviors of the virtual entity.

### Supplementary 2

The system according to supplementary 1,

wherein the processor is configured to

analyze, based on the updated behavior plan data and the emotion state data, history information regarding an execution status of behaviors by the user, generate context information including an analysis result, and append the context information to the prompt sentence to be input to the generative AI model, thereby causing the generative AI model to execute behavior generation processing that progressively personalizes the behavior plan data of the virtual entity according to an adherence tendency of the user.

### Supplementary 3

The system according to supplementary 1,

wherein the processor is configured to

generate, based on the updated behavior plan data, a prompt sentence to be input to the generative AI model from a free-form query text representing an additional request input by the user, acquire behavior candidate data from the generative AI model in accordance with the prompt sentence, integrate the behavior candidate data into the behavior plan data as additional or modified behavior items, and cause the terminal device to present the integrated behavior items as selectable real-world behavior options for the user.

What is claimed is:

1. A system comprising:
a communication interface coupled to a packet-switched network; and
circuitry configured to:
receive objective information from a terminal device via the communication interface and store the objective information in a storage device;
generate, based on the objective information, a prompt for instructing a generative neural network model to generate text information describing action sequences of a simulated entity aligned with the objective information, and input the prompt to the generative neural network model to obtain the text information;
analyze the text information by executing parsing logic that converts the text information into structured plan data comprising a plurality of action elements each having at least time information, period information, category information, and description information;
transmit presentation data based on the structured plan data to the terminal device via the packet-switched network; and
calculate an achievement degree of the structured plan data based on execution status information received from the terminal device, generate an update prompt reflecting the achievement degree, input the update prompt to the generative neural network model, and update the structured plan data based on updated text information obtained from the generative neural network model.

2. The system according to claim 1, wherein the circuitry is further configured to format the structured plan data into a sequential schedule comprising time-indexed entries, each entry including a category label and a description string derived from the corresponding action element.

3. The system according to claim 2, wherein the parsing logic comprises pattern matching on the text information to identify delimiters, headings, and enumerated items, and mapping extracted text segments to respective fields of the action elements.

4. The system according to claim 3, wherein the circuitry is further configured to validate the structured plan data by checking that each action element includes non-empty values for the time information, the period information, the category information, and the description information, and to request regeneration of action elements that fail validation.

5. The system according to claim 4, wherein the prompt includes contextual constraints comprising a time frame, resource availability parameters, and preference parameters derived from the objective information, and wherein the generative neural network model generates the text information conditioned on the contextual constraints.

6. The system according to claim 1, wherein the circuitry is further configured to receive execution status information comprising completion flags, timestamp data, and partial-completion indicators for individual action elements, and to calculate the achievement degree as a ratio of completed action elements to total action elements weighted by category priorities.

7. The system according to claim 6, wherein the update prompt includes the achievement degree, identifiers of incomplete action elements, and instructions for the generative neural network model to generate replacement or supplementary action elements adapted to the execution status.

8. The system according to claim 7, wherein the circuitry is further configured to compare the updated structured plan data with the prior structured plan data and to identify modified, added, and removed action elements for display as differential presentation data on the terminal device.

9. The system according to claim 1, wherein the circuitry is further configured to generate visual content data representing the simulated entity by constructing an image-generation prompt based on attribute information derived from the objective information and inputting the image-generation prompt to an image generative neural network model.

10. The system according to claim 9, wherein the attribute information comprises at least physical characteristic parameters and behavioral style parameters extracted from the text information, and wherein the visual content data is transmitted to the terminal device together with the presentation data.

11. The system according to claim 1, wherein the circuitry is further configured to perform emotion estimation processing on input data received from the terminal device to generate emotion state data, and to incorporate the emotion state data into the prompt to cause the generative neural network model to adapt expression intensity and encouragement parameters in the text information.

12. The system according to claim 11, wherein the circuitry is further configured to generate, based on the emotion state data and the structured plan data, an additional prompt for the generative neural network model to update the structured plan data to include action elements adapted to the estimated emotional state.

13. The system according to claim 1, wherein the circuitry is further configured to analyze history information regarding an execution status of action elements over a plurality of update cycles, generate context information comprising an analysis result including adherence tendency metrics, and append the context information to the prompt to cause the generative neural network model to progressively personalize the structured plan data.

14. The system according to claim 13, wherein the adherence tendency metrics comprise a completion rate per category, a variance in execution timing, and a streak count indicating consecutive periods of action element completion.

15. The system according to claim 1, wherein the circuitry is further configured to receive free-form query text from the terminal device, generate a query prompt based on the query text and the structured plan data, input the query prompt to the generative neural network model to obtain candidate action data, and integrate the candidate action data into the structured plan data as additional or modified action elements.

16. The system according to claim 1, wherein the objective information comprises a user goal relating to at least one of health improvement, skill acquisition, or productivity enhancement, and wherein the action elements comprise specific daily or periodic tasks toward achievement of the user goal.

17. The system according to claim 16, wherein the circuitry is further configured to calculate a closed-loop induction rate based on a ratio of adopted action elements to total presented action elements across update cycles, and to adjust generation parameters of the generative neural network model when the induction rate falls below a threshold.

18. A system comprising:
a communication interface coupled to a packet-switched network; and
circuitry configured to:
receive objective information from a terminal device via the communication interface and store the objective information in a storage device in association with a session identifier;
generate a prompt including the objective information, contextual constraints comprising a time frame and preference parameters, and attribute information for a simulated entity, and input the prompt to a generative neural network model to obtain text information describing action sequences aligned with the objective information;
parse the text information using pattern matching and delimiter extraction to generate structured plan data comprising a plurality of action elements each having time information, period information, category information, and description information, and validate completeness of the action elements;
calculate an achievement degree based on execution status information received from the terminal device comprising completion flags and timestamp data, the achievement degree being a weighted ratio of completed action elements to total action elements;
generate an update prompt including the achievement degree, identifiers of incomplete action elements, and adherence tendency metrics derived from execution history, input the update prompt to the generative neural network model, and update the structured plan data based on updated text information; and
perform emotion estimation processing on input data from the terminal device to generate emotion state data, incorporate the emotion state data into subsequent prompts, and transmit presentation data including the structured plan data to the terminal device via the packet-switched network.

19. The system according to claim 18, wherein the circuitry is further configured to generate visual content data representing the simulated entity by constructing an image-generation prompt based on physical characteristic parameters and behavioral style parameters extracted from the text information and inputting the image-generation prompt to an image generative neural network model.

20. A method comprising:
receiving, by circuitry coupled to a packet-switched network, objective information from a terminal device and storing the objective information in a storage device;
generating a prompt for instructing a generative neural network model to generate text information describing action sequences of a simulated entity aligned with the objective information, and inputting the prompt to the generative neural network model to obtain the text information;
analyzing the text information by executing parsing logic to convert the text information into structured plan data comprising a plurality of action elements each having time information, period information, category information, and description information;
transmitting presentation data based on the structured plan data to the terminal device via the packet-switched network; and
calculating an achievement degree based on execution status information received from the terminal device, generating an update prompt reflecting the achievement degree, inputting the update prompt to the generative neural network model, and updating the structured plan data based on updated text information.
